(19) United States
(12) Patent Application Publication
(10) Pub. No.: US 2007/0006110 A1
(43) Pub. Date: Jan. 4, 2007

(54) Net list conversion method, net list conversion device, still-state leak current detection method, and still-state leak current detection device

(75) Inventors: Junichi Naka, Osaka (JP); Koji Oka, Osaka (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Osaka (JP)

(21) Appl. No.: 10/574,498

(22) PCT Filed: May 17, 2004
(86) PCT No.: PCT/JP04/07006

§ 371 Date: Apr. 3, 2006

(30) Foreign Application Priority Data
Oct. 3, 2003 (JP) 2003-346185

(51) Int. Cl. G06F 17/50

(52) U.S. Cl. 716/12

(57) ABSTRACT

As shown in FIG. 1, a gate terminal of a MOS transistor or an input terminal of a logic gate, which are included in a through current detection target net list, are extracted, and a resistor is inserted between the gate terminal of the MOS transistor or the input terminal of the logic gate and a power supply, and between the gate terminal of the MOS transistor or the input terminal of the logic gate and a reference voltage, respectively, thereby to perform net list conversion, and thereafter, DC analysis is executed. Therefore, a MOS transistor in which through current might occur can be detected, leading to reliable detection of through current that cannot be easily detected by the conventional DC analysis simulation, and reliable detection of a transistor in which through current might occur, in the through current detection target circuit.

### TECHNICAL FIELD

The present invention relates to a method and an apparatus for detecting a through current under a stationary state in an analog CMOS circuit, and a method and apparatus for net list conversion relating thereto.

### BACKGROUND ART

In recent years, from the aspect of the necessity of long-hour driving with a limited power, which is accompanied by development of mobiles, as well as the aspect of protection of global environment, power reduction for realizing energy saving is indispensable, and therefore, a system of low power consumption is required. So, it is important to frequently power down unnecessary circuits in the system, and reduction in power consumption under a stationary state has a very important role. Especially in an analog CMOS circuit, not only its large power scale but also unexpected through current under a stationary state become problems.

A major cause of through current in an LSI is as follows. That is, when an input terminal or a gate terminal of a transistor is connected to a node where a logic gate circuit input terminal or a transistor gate electrode is in its open state or high impedance state, an intermediate voltage between a power supply voltage and a ground voltage is electrically connected to the logical gate circuit input terminal and the transistor gate terminal, or to the input terminal and the transistor gate terminal due to floating capacitance, parasitic resistance or the like, whereby through current flows in the transistor.

As a method for detecting such through current, there is proposed a method in which, when executing CMOS logic gate simulation, a logic gate A is noticed, and when the output of the logic gate A is unfixed, it is checked whether a subsequent-stage logic gate B connected to the logic gate A propagates the unfixed state or not, thereby to determine whether there is a possibility of occurrence of through current in the logic gate B (for example, refer to Japanese Published Patent Application No. Hei. 7-28879 (Page 5, FIGS. 1-3), Japanese Published Patent Application No. 2002-163322, Japanese Published Patent Application No. 2003-186935).

However, many of through current detection methods as described above are intended to a circuit constituted by only CMOS logic gates, and they are not applicable to an analog CMOS circuit. Detection of through current in an analog CMOS circuit is not easier than detection of through current in a CMOS logic gate circuit, and therefore, the above-mentioned through current detection method cannot be utilized, and a method therefor has not yet been established.

Presently, as a common method for detecting through current in an analog CMOS circuit under a stationary state, there is employed DC analysis simulation. The DC analysis simulation is a method of analyzing a DC operation point under a stationary state where a capacitor component is released and an inductor component is short-circuited. More specifically, the method comprises: 1) initially giving stationary-state characteristics to a target circuit, 2) performing DC analysis simulation, and 3) monitoring current in a MOS transistor in the target circuit.

The above-mentioned detection method will be described using a circuit 3701 shown in FIG. 37(a) as an example.

The circuit 3701 comprises an OP1 as an operational amplifier OpAmp, a MN1 as a Nch MOS transistor, a MP1 as a Pch MOS transistor, a resistor R1, and a power supply AVDD.

More specifically, an output A of the OP1 is connected to a gate electrode of the MN1 through a net a, a source electrode of the MN1 is connected to an end of the R1 and to a negative-side input N of the OP1 through a net b, a drain electrode of the MN1 is connected to a drain electrode of the MP1 and to a gate electrode of the MP1 through a net c, and a source electrode of the MP1 is connected to the power supply AVDD. The other end of the R1 is connected to a ground voltage GND, a reference voltage VREF is connected to a positive-side input P of the OP1, and a control signal ENABLE1 for the OP1 is connected to a control terminal E of the OP1. Further, 11 denotes a current that flows from the power supply AVDD to the ground voltage through a source terminal of the MP1, a drain terminal of the MP1, the net c, a drain terminal of the MN1, a source terminal of the MN1, the net b, and the R1. The OP1 performs normal amplification when the ENABLE1 is “H”, and the OP1 is powered down when the ENABLE1 is “L” and thereby an output A of the OP1 becomes Hi-Z.

Hereinafter, the operation of the circuit 3701 constituted as mentioned above will be described. When the ENABLE1 is “H” and an appropriate voltage is applied to the VREF, the OP1 performs normal amplification, and the voltage at the net b becomes equal to the VREF, while the net a becomes equal to a voltage with which a current I1=VREF/R1 flows, as a DC operation point of the MN1. That is, this circuit operates as a bias circuit performing voltage-to-current conversion. On the other hand, when the ENABLE1 becomes “L”, the OP1 is powered down, and the output A of the OP1 becomes Hi-Z. At this time, the voltage at the a point as the gate terminal of the MN1 is unfixed, leading to a great possibility that through current might flows at the I1.

However, when subjecting the circuit 3071 to the DC analysis simulation which is the general through current detection method, even though the DC analysis simulation is carried out with the ENABLE1 being “L” that is stationary-state characteristic, since, in many cases, the a point is artificially fixed to the reference voltage when the output A of the OP1 becomes Hi-Z, current hardly flows at the I1. Therefore, it is very difficult to detect a position where through current might flow, even through such DC analysis simulation is executed.

Further, the above-mentioned detection method will be described employing a circuit 3702 shown in FIG. 37(b) as another example.

The circuit 3702 comprises a TBUF1 as a tri-state buffer, a MN2 as a Nch MOS transistor, a MP2 as a Pch MOS transistor, and a power supply VDD, and the MN2 and the MP2 constitute an inverter.

To be specific, an output OUT of the TBUF1 is connected to a gate electrode of the MN2 and a gate electrode of the MP2 through a net d, a source electrode of the MN2 is connected to a ground voltage GND, a drain electrode of the MN2 and a drain electrode of the MP2 are connected to be an output signal DOUT, a source electrode of the MP2 is connected to a power supply VDD, an input signal DIN is connected to an input terminal IN of the TBUF1, and a control signal ENABLE2 for the TBUF1 is connected to a control terminal E of the TBUF1. Further, 12 denotes a current that flows from the power supply VDD to the ground voltage through a source terminal of the MP2, a drain terminal of the MP2, the net DOUT, a drain terminal of the MN2, and a source terminal of the MN2, that is, 12 is through current of the inverter comprising the MN2 and the MP2. When the ENABLE2 is “H”, the TBUF1 performs normal buffering, whereby the output OUT of the TBUF1 becomes equal to the DIN as an input of the TBUF1. On the other hand, when the ENABLE2 is “L”, the output OUT of the TBUF1 becomes Hi-Z.

Hereinafter, the operation of the circuit 3702 constituted as described above will be described. When the ENABLE2 is “H” and an appropriate signal is applied to the DIN, the output OUT of the TBUF1 becomes equal to the input signal DIN of the TBUF1, and the input of the inverter comprising the MN2 and the MP2 becomes equal to the DIN, and consequently, the output DOUT of the inverter becomes an inverted output of the DIN. Since, generally, current flows in an inverter only during a transition period, current hardly flows at the I2 in a stationary state. On the other hand, when the ENABLE2 becomes “L”, the output OUT of the TBUF1 becomes Hi-Z. At this time, the voltage at the d point as the gate terminal of the MN2 and the MP2 becomes unfixed, leading to a great possibility of through current flowing at the I2.

However, when subjecting the circuit 3072 to the DC analysis simulation which is the general through current detection method, even though the DC analysis simulation is carried out with the ENABLE2 being “L”, since, in many cases, the d point is artificially fixed to the reference voltage when the output OUT of the TBUF1 becomes Hi-Z, current hardly flows at the I2. Therefore, it is very difficult to detect a position where through current might flow.

As described above, in the conventional DC analysis simulation, even when there is a possibility that through current might flow in a stationary state because the output from the output terminal of a certain circuit in the target circuit is Hi-Z and this output terminal is connected to the gate electrode of the MOS transistor, since the voltages at the gate electrode of the open-state transistor and at the input terminal of the logic gate circuit are artificially connected to the ground voltage GND to perform simulation, there is a high possibility that the through current cannot be detected.

Now it is considered to perform searching for the gate terminal of the MOS transistor and the input terminal of the logic gate circuit, which are in their open states, from the net list of the target circuit, thereby detecting a MOS transistor that is suspected of causing through current. A method for this detection comprises: 1) initially, detecting a transistor included in the net list of the target circuit, that is, included in the target circuit, 2) extracting a net name of a gate terminal of the detected transistor, and 3) when the extracted net name is not connected to other terminals than the gate terminal of the detected transistor, determining that the gate electrode of the transistor is in its open state and thereby the transistor is suspected of causing through current. In the above-mentioned method, however, when a target circuit comprises a switch circuit and an inverter circuit as shown in FIG. 38, since an I/O terminal of the switch circuit is connected to an input of the inverter, it cannot be checked as to whether the gate terminal of the MOS transistor is in its open state or not, when viewed from the gate terminal of the MOS transistor in the inverter circuit. Therefore, it is difficult to reliably detect a transistor that is suspected of causing through current in the inverter circuit.

The present invention is made to solve the above-mentioned problems and has for its object to provide a stationary through current detection method and apparatus which can reliably detect through current that is hard to detect by the conventional DC analysis simulation, and a net list conversion method and apparatus for converting a net list of a detection target circuit so as to reliably detect a transistor that is suspected of causing through current in the through current detection target circuit.

### DISCLOSURE OF THE INVENTION

A net list conversion method according to the present invention comprises: a net list designation step of designating a net list to be subjected to detection of through current in a stationary state; a net extraction step of extracting a net connected to a gate terminal of a MOS transistor from the detection target net list, and storing the extracted net in a extracted net database which is provided for each of MOS transistors having different threshold values; and a resistor insertion step of inserting a resistor element having a unique resistor element name, between the extracted net that is connected to the gate terminal of the extracted MOS transistor and a power supply that is determined for each threshold value of the MOS transistor, and between the extracted net and a reference voltage, in the detection target net list, on the basis of the extracted net database that is provided for each of the MOS transistors having different threshold values.

Therefore, whether the stationary-state through current detection target circuit is an analog CMOS circuit or a CMOS logic circuit, it is possible to reliably detect a position where through current might flow in stationary state. Further, it is possible to fix a gate terminal of a MOS transistor in which through current might flow, to a voltage between the power supply and the reference voltage.

Further, in the net list conversion method of the present invention, the net extraction step comprises: a MOS transistor detection step of detecting a MOS transistor in the detection target net list; a net detection step of detecting a net connected to a gate terminal of the detected MOS transistor, and storing the detected net in the extracted net database; and a resistor element detection step of detecting a resistor element in the detected target net list, and storing a resistor element name of the detected resistor element in a resistor element name database.

Therefore, it is possible to reliably detect a net in which through current might flow in stationary state, in the through current detection target circuit.

Further, in the net list conversion method of the present invention, the MOS transistor detection step checks whether a first character in each row included in the detection target net list is “M” or not, and determines that the corresponding row describes about a MOS transistor when the first character in the row is “M”.

Therefore, it is possible to reliably detect MOS transistors in the through current detection target circuit.

Further, in the net list conversion method of the present invention, the net detection step comprises: detecting, from a row determined as describing about a MOS transistor in the MOS transistor detection step, a net connected to the gate terminal of the MOS transistor; determining a threshold value of the MOS transistor from a model name of the MOS transistor, said model name being indicated by a sixth character string in the row; and storing the net that is connected to the gate terminal of the MOS transistor, in a database of the corresponding threshold value among the extracted net databases which are provided for the respective threshold values of the MOS transistor.

Therefore, it is possible to reliably detect a net that is connected to a gate terminal of a MOS transistor in the through current detection target circuit.

Further, in the net list conversion method of the present invention, the resistor element detection step comprises: checking whether a first character in each row included in the detection target net list is “R” or not, and determines that the corresponding row describes about a resistor element when the first character in the row is “R”; extracting a first character string in the row that is determined as describing about a resistor element, as a resistor element name of the resistor element; and storing the extracted resistor element name in the resistor element name database.

Therefore it is possible to reliably detect resistor elements included in the through current detection target circuit.

Further, in the net list conversion method of the present invention, the resistor insertion step comprises: creating a new resistor element name to be a unique resistor element name by searching the resistor element name database; adding a resistor element having the created new resistor element name into the net list so as to connect a net that is stored in the extracted net database which is provided for each of MOS transistors having different threshold values with the power supply that is determined for each threshold value of the MOS transistor, and connect the stored net with the reference voltage; and adding the resistor element name of the added resistor element into the resistor element name database.

Therefore, it is possible to insert a resistor element in a position where through current might flow, in the through current detection target circuit.

Further, the net list conversion method of the present invention further includes an overlapping net deletion step of deleting a net that overlaps in each extracted net database, among the nets extracted in the net extraction step and stored in the extracted net database which is provided for each of MOS transistors having difference threshold values, and the resistor insertion step inserting a resistor element having a unique resistor element name, between the net connected to the gate terminal of the MOS transistor and the power supply that is determined for each threshold value of the MOS transistor, and between the net and the reference voltage, in the detection target net list, on the basis of the extracted net database from which the overlapping net is deleted by the overlapping net deletion step.

Therefore, it is possible to minimize the number of resistor elements to be inserted in the through current detection target circuit.

Further, in the net list conversion method of the present invention, the overlapping net deletion step comprises: reading the extracted net database that is provided for each of MOS transistors having different threshold values; rearranging the nets stored in the read extracted net database in lexicographical order; and searching the rearranged extracted net database from the beginning, and deleting a net that is identical to a net as a search target.

Therefore, it is possible to prevent overlapping of positions where resistor elements are inserted in net lists, in the through current detection target circuit.

Further, the net list conversion method of the present invention further includes a net number counting step of reading the extracted net database that is provided for each of MOS transistors having different threshold values, and counting, for each extracted net database, the number of nets included in the extracted net database.

Therefore, it is possible to count the number of nets extracted from the net list of the through current detection target circuit, thereby obtaining the number of nets to which resistor elements should be inserted by the net list conversion process.

Further, a net list conversion method of the present invention comprises: a net list designation step of designating a net list to be subjected to detection of through current in a stationary state; a sub-circuit replacement step of replacing a MOS transistor in the detection target net list with a sub-circuit according to a threshold value and type of the MOS transistor; and a sub-circuit addition step of adding, into the detection target net list, sub-circuit information of the sub-circuit with which the MOS transistor is replaced.

Therefore, whether the stationary-state through current detection target circuit is an analog CMOS circuit or a CMOS logic circuit, it is possible to reliably detect a position where through current might flow in stationary state. Further, it is possible to fix a gate terminal of a MOS transistor in which through current might flow, to a voltage between the power supply and the reference voltage. Furthermore, with respect to the net list converted by the net list conversion method, resistor elements are added in the net list while maintaining the net list before the conversion, whereby the construction of the detection target circuit can easily be known from the net list after the net list conversion.

Further, the net list conversion method of the present invention further includes a replaced transistor number counting step of counting the number of MOS transistors that are replaced with sub-circuits according to the threshold values and types of the MOS transistors by the sub-circuit replacement step.

Therefore, it is possible to count the replaced MOS transistors in the net list of the through current detection target circuit, thereby obtaining the number of nets in which resistor elements are inserted by the net list conversion process.

Further, in the net list conversion method of the present invention, the sub-circuit replacement step comprises: detecting a MOS transistor in the detection target net list; determining a threshold value of the MOS transistor from a model name of the MOS transistor, said model name being indicated by a sixth character string in a row that describes about the detected MOS transistor; replacing the description of the detected MOS transistor with a sub-circuit according to the threshold value and type of the MOS transistor; and adding “X” at the top of a first character string in a row of the sub-circuit with which the MOS transistor is replaced, and describing, in the row, connection information comprising “drain terminal”, “gate terminal”, “source terminal”, and “bulk terminal” and parameter information comprising “W:channel width”, “L:channel length”, “M:multiplier”, which correspond to second, third, fourth and fifth character strings of the description of the MOS transistor before being replaced with the sub-circuit.

Therefore, it is possible to replace a MOS transistor in which through current might occur, in the through current detection target circuit, with a sub-circuit.

Further, in the net list conversion method of the present invention, the sub-circuit addition step adds the sub-circuit information to the detection target net list; and the sub-circuit information includes a MOS transistor according to the threshold value and type of the MOS transistor that is replaced with the sub-circuit, and a resistor element that is inserted between the gate terminal of the MOS transistor and a power supply according to the threshold value of the MOS transistor, and between the gate terminal of the MOS transistor and a reference voltage.

Therefore, it is possible to insert a resistor element in a position where through current might occur, in the through current detection target circuit.

Further, a net list conversion method of the present invention comprises: a net list designation step of designating a net list to be subjected to detection of through current in a stationary state; a first net extraction step of extracting a net connected to a gate terminal of a MOS transistor from the detection target net list, and storing the extracted net in an extracted net database which is provided for each of MOS transistors having different threshold values; a second net extraction step of extracting a net connected to an input terminal of a sub-circuit from the detection target net list, and storing the extracted not in an extracted net database which is provided for each of the MOS transistors having different threshold values; and a resistor insertion step of inserting a resistor element having a unique resistor element name, between the net extracted in the first net extraction step and the second net extraction step and a power supply, and between the extracted net and a reference voltage, in the detection target net list, on the basis of the extracted net database that is provided for each of the MOS transistors having different threshold values.

Therefore, whether the stationary-state through current detection target circuit is an analog CMOS circuit or a CMOS logic circuit, it is possible to reliably detect a position where through current might flow in stationary state. Further, it is possible to fix a gate terminal of a MOS transistor in which through current might flow, to a voltage between the power supply and the reference voltage. Furthermore, even when a sub-circuit is included in the net list, it is possible to reliably detect a position where through current might be detected, in the sub-circuit.

Further, in the net list conversion method of the present invention, the second net extraction step checks whether a first character in each row included in the detection target net list is “X” or not, and determines that the corresponding row describes about a sub-circuit when the first character in the row is “X”.

Therefore, it is possible to reliably detect a sub-circuit in the leakage current detection target circuit.

Further, the net list conversion method of the present invention further includes an overlapping net deletion step of deleting a net that overlaps in each extracted net database, among the nets extracted in the first net extraction step and the second net extraction step and then stored in the extracted net database which is provided for each of MOS transistors having difference threshold values, and the resistor insertion step of inserting a resistor element having a unique resistor element name, between the net extracted in the first net extraction step and the second net extraction step and the power supply, and between the extracted net and the reference voltage, in the detection target net list, on the basis of the extracted net database from which the overlapping net is deleted in the overlapping net deletion step.

Therefore, it is possible to prevent overlapping of positions where resistor elements are to be inserted, in the net list of the through current detection target circuit, thereby further reducing the number of resistor elements to be inserted in the through current detection target circuit.

Further, the net list conversion method of the present invention further includes a net number counting step of reading the extracted net database that is provided for each of the MOS transistors having different threshold values, and counting the number of nets included in the extracted net database, for each extracted net database.

Therefore, it is possible to obtain the number of nets in which resistor elements are inserted, by counting the number of nets extracted from the net list of the through current detection target circuit.

Further, the net list conversion method of the present invention further includes a comparison step of comparing the sub-circuit extracted in the second net extraction step with a sub-circuit database in which specific sub-circuit is entered; and the resistor insertion step inserts a resistor element having a unique resistor element name, between the net extracted in the first net extraction step and the power supply, and between the extracted net and the reference voltage, in the detection target net list, on the basis of the extracted net database that is provided for each of the MOS transistors having different threshold values, and inserts a resistor element having a unique resistor element name between a net other than a net included in a sub-circuit that is determined as being entered in the sub-circuit database in the comparison step among the sub-circuits extracted in the second net extraction step, and the power supply, and between the net and the reference voltage, in the detection target net list.

Therefore, it is possible to fix a gate terminal of a MOS transistor in which through current might flow, to a voltage between the power supply and the reference voltage. Furthermore, it becomes unnecessary to insert a resistor in a highly reliable sub-circuit which has previously been recognized as having no through current, thereby significantly reducing the number of resistor elements to be inserted in the detection target circuit.

Further, a net list conversion apparatus of the present invention comprises: a net list designation unit for designating a net list to be subjected to detection of through current in a stationary state; a net extraction unit for extracting a net connected to a gate terminal of a MOS transistor from the detection target net list, and storing the extracted net in a extracted net database which is provided for each of MOS transistors having different threshold values; and a resistor insertion unit for inserting a resistor element having a unique resistor element name, between the extracted net that is connected to the gate terminal of the extracted MOS transistor and a power supply that is determined for each threshold value of the MOS transistor, and between the extracted net and a reference voltage, in the detection target net list, on the basis of the extracted net database that is provided for each of the MOS transistors having different threshold values.

Therefore, whether the stationary-state through current detection target circuit is an analog CMOS circuit or a CMOS logic circuit, it is possible to reliably detect a position where through current might flow in stationary state. Further, it is possible to fix a gate terminal of a MOS transistor in which through current might flow, to a voltage between the power supply and the reference voltage.

Further, the net list conversion apparatus of the present invention further includes an overlapping net deletion unit for deleting a net that overlaps in each extracted net database, among the nets extracted by the net extraction unit and stored in the extracted net database which is provided for each of the MOS transistors having difference threshold values; and the resistor insertion unit inserting a resistor element having a unique resistor element name, between the net connected to the gate terminal of the MOS transistor and the power supply that is determined for each threshold value of the MOS transistor, and between the net and the reference voltage, in the detection target net list, on the basis of the extracted net database from which the overlapping net is deleted by the overlapping net deletion unit.

Therefore, it is possible to minimize the number of resistor elements to be inserted in the through current detection target circuit.

Further, the net list conversion apparatus of the present invention further includes a net number counting unit for reading the extracted net database that is provided for each of MOS transistors having different threshold values, and counting, for each extracted net database, the number of nets included in the extracted net database.

Therefore, it is possible to count the number of nets extracted from the net list of the through current detection target circuit, thereby obtaining the number of nets to which resistor elements are to be inserted by the net list conversion process.

Further, a net list conversion apparatus of the present invention comprises: a net list designation unit for designating a net list to be subjected to detection of through current in a stationary state; a sub-circuit replacement unit for replacing a MOS transistor in the detection target net list with a sub-circuit according to a threshold value and type of the MOS transistor; and a sub-circuit addition unit for adding, into the detection target net list, sub-circuit information of the sub-circuit with which the MOS transistor is replaced.

Therefore, whether the stationary-state through current target circuit is an analog CMOS circuit or a CMOS logic circuit, it is possible to reliably detect a position where through current might flow in stationary state. Further, it is possible to fix a gate terminal of a MOS transistor in which through current might flow, to a voltage between the power supply and the reference voltage. Furthermore, with respect to the net list converted by the net list conversion method, resistor elements are added in the net list while maintaining the net list before the conversion, whereby the construction of the detection target circuit can easily be known from the net list after the net list conversion.

Further, the net list conversion apparatus of the present invention further includes a replaced transistor number counting unit for counting the number of MOS transistors that are replaced with sub-circuits according to the threshold values and types of the MOS transistors by the sub-circuit replacement unit.

Therefore, it is possible to count the replaced MOS transistors in the net list of the through current detection target circuit, thereby obtaining the number of nets in which resistor elements are to be inserted by the net list conversion process.

Further, a net list conversion apparatus of the present invention comprises: a net list designation unit for designating a net list to be subjected to detection of through current in a stationary state; a first net extraction unit for extracting a net connected to a gate terminal of a MOS transistor from the detection target net list, and storing the extracted net in an extracted net database which is provided for each of MOS transistors having different threshold values; a second net extraction unit for extracting a net connected to an input terminal of a sub-circuit from the detection target net list, and storing the extracted not in an extracted net database which is provided for each of the MOS transistors having different threshold values; and a resistor insertion unit for inserting a resistor element having a unique resistor element name, between the net extracted by the first net extraction unit and the second net extraction unit and a power supply, and between the extracted net and a reference voltage, in the detection target net list, on the basis of the extracted net database that is provided for each of the MOS transistors having different threshold values.

Therefore, whether the stationary-state through current detection target circuit is an analog CMOS circuit or a CMOS logic circuit, it is possible to reliably detect a position where through current might flow in stationary state. Further, it is possible to fix a gate terminal of a MOS transistor in which through current might flow, to a voltage between the power supply and the reference voltage. Furthermore, even when a sub-circuit is included in the net list, it is possible to reliably detect a position where through current might be detected, in the sub-circuit.

Further, the net list conversion apparatus of the present invention further includes an overlapping net deletion unit for deleting a net that overlaps in each extracted net database, among the nets extracted by the first net extraction unit and the second net extraction unit and then stored in the extracted net database which is provided for each of MOS transistors having difference threshold values; and the resistor insertion unit for inserting a resistor element having a unique resistor element name, between the net extracted by the first net extraction unit and the second net extraction unit and the power supply, and between the extracted net and the reference voltage, in the detection target net list, on the basis of the extracted net database from which the overlapping net is deleted by the overlapping net deletion unit.

Therefore, it is possible to prevent overlapping of positions where resistor elements are to be inserted, in the net list of the through current detection target circuit, thereby further reducing the number of resistor elements to be inserted in the through current detection target circuit.

Further, the net list conversion apparatus of the present invention further includes a net number counting unit for reading the extracted net database that is provided for each of the MOS transistors having different threshold values, and counting the number of nets included in the extracted net database, for each extracted net database.

Therefore, it is possible to count the number of nets extracted from the net list of the through current detection target circuit, thereby obtaining the number of nets in which resistor elements are to be inserted by the net list conversion process.

Further, a stationary through current detection method of the present invention comprises: a net list conversion step of converting a net list to be subjected to detection of through current in a stationary state, by using a net list conversion method according to any of Claims 1, 10, and 14; a DC analysis step of subjecting a post-conversion net list obtained in the net list conversion step to DC analysis to obtain a DC analysis result; and a transistor search step of searching for a MOS transistor in which through current might occur, in the detection target net list, on the basis of the DC analysis result obtained in the DC analysis step.

Therefore, whether the stationary-state through current detection target circuit is an analog CMOS circuit or a CMOS logic circuit, it is possible to easily detect a position where through current might occur, which position is difficult to detect by the conventional DC analysis, when performing stationary-state through current detection.

Further, in the stationary through current detection method of the present invention, the transistor search step comprises: determining, on the basis of the DC analysis result, as to whether a current |Ids| that flows in a MOS transistor in the detection target net list exceeds a predetermined current threshold value Ith or not; and storing a MOS transistor in which the current |Ids| exceeds the current threshold value Ith, as a current through MOS transistor, in a current through MOS transistor database.

Therefore, it is possible to detect a MOS transistor in which through current occurs, in the stationary-state through current detection target circuit.

Further, a stationary through current detection method of the present invention comprises: a net list conversion step of converting a net list to be subjected to detection of through current in a stationary state, by using a net list conversion method according to any of Claims 9, 11, and 17; a DC analysis step of subjecting a post-conversion net list obtained in the net list conversion step to DC analysis to obtain a DC analysis result; a transistor search step of searching for a MOS transistor in which through current might occur, in the detection target net list, on the basis of the DC analysis result obtained in the DC analysis step; and a total through current calculation step of calculating total through current in the detection target net list.

Therefore, whether the stationary-state through current detection target circuit is an analog CMOS circuit or a CMOS logic circuit, it is possible to easily detect a position where through current might occur, which position is difficult to detect by the conventional DC analysis, when performing stationary-state through current detection, and further, it is possible to calculate through current that occurs in the through current detection target circuit.

Further, in the stationary through current detection method of the present invention, the total through current calculation step subtracts (number of extracted nets*((power supply voltage−reference voltage)/(inserted resistance value*2)) or (number of replaced transistors*((power supply voltage−reference voltage)/(inserted resistance value*2)) from a current which flows between the power supply that is determined for each threshold value of the MOS transistor and the reference voltage, on the basis of the DC analysis result, and the number of nets included in the extracted net database or the number of MOS transistors replaced with sub-circuits.

Therefore, it is possible to calculate through current that occurs in the stationary-state through current detection target circuit, on the basis of the number of nets included in the extracted net database or the number of MOS transistors replaced with sub-circuits.

Further, a stationary through current detection method of the present invention comprises: a net list conversion step of converting a net list to be subjected to detection of through current in a stationary state, by using a net list conversion method according to any of Claims 1, 10, and 14; and a histogram formation step of subjecting a post-conversion net list obtained in the net list conversion step to DC analysis, and forming a histogram relating to through currents |Ids| in MOS transistors in the detection target net list on the basis of the DC analysis result.

Therefore, it is possible to visually detect a position where through current might occur, in the stationary-state through current detection target circuit.

Further, a stationary through current detection apparatus of the present invention comprises: a net list conversion unit for converting a net list to be subjected to detection of through current in a stationary state, by using a net list conversion apparatus according to any of Claims 19, 22, and 24; a DC analysis unit for subjecting a post-conversion net list obtained by the net list conversion unit to DC analysis to obtain a DC analysis result; and a transistor search unit for searching for a MOS transistor in which through current might occur, in the detection target net list, on the basis of the DC analysis result obtained by the DC analysis unit.

Therefore, whether the stationary-state through current detection target circuit is an analog CMOS circuit or a CMOS logic circuit, it is possible to easily detect a position where through current might occur, which position is difficult to detect by the conventional DC analysis, when performing stationary-state through current detection.

Further, a stationary through current detection apparatus of the present invention comprises: a net list conversion unit for converting a net list to be subjected to detection of through current in a stationary state, by using a net list conversion apparatus according to any of Claims 21, 23, and 26; a DC analysis unit for subjecting a post-conversion net list obtained by the net list conversion unit to DC analysis to obtain a DC analysis result; a transistor search unit for searching for a MOS transistor in which through current might occur, in the detection target net list, on the basis of the DC analysis result obtained by the DC analysis unit; and a total through current calculation unit for calculating total through current in the detection target net list.

Therefore, whether the stationary-state through current detection target circuit is an analog CMOS circuit or a CMOS logic circuit, it is possible to easily detect a position where through current might occur, which position is difficult to detect by the conventional DC analysis, when performing stationary-state through current detection, and further, it is possible to calculate through current that occurs in the through current detection target circuit.

Further, a stationary through current detection apparatus of the present invention comprises: a net list conversion unit for converting a net list to be subjected to detection of through current in a stationary state, by using a net list conversion apparatus according to any of Claims 19, 22, and 24; and a histogram formation unit for subjecting a post-conversion net list obtained by the net list conversion unit to DC analysis, and forming a histogram relating to through currents |Ids| in MOS transistors in the detection target net list on the basis of the DC analysis result.

Therefore, it is possible to visually detect a position where through current might occur, in the stationary-state through current detection target circuit.

Further, a program of the present invention is a net list conversion program for making a computer execute a net list conversion process for a net list to be subjected to detection of through current in a stationary state, and the program comprises: a net list designation step of designating the net list; a net extraction step of extracting a net connected to a gate terminal of a MOS transistor from the detection target net list, and storing the extracted net in a extracted net database which is provided for each of MOS transistors having different threshold values; and a resistor insertion step of inserting a resistor element having a unique resistor element name, between the extracted net that is connected to the gate terminal of the extracted MOS transistor and a power supply that is determined for each threshold value of the MOS transistor, and between the extracted net and a reference voltage, in the detection target net list, on the basis of the extracted net database that is provided for each of the MOS transistors having different threshold values.

Therefore, whether the stationary-state through current detection target circuit is an analog CMOS circuit or a CMOS logic circuit, it is possible to, with a computer, reliably detect a position where through current might flow in stationary state, and fix a gate terminal of a MOS transistor in which through current might flow, to a voltage between the power supply and the reference voltage.

Further, a program of the present invention is a net list conversion program for making a computer execute a net list conversion process for a net list to be subjected to detection of through current in a stationary state, and the program comprises: a net list designation step of designating the net list; a sub-circuit replacement step of replacing a MOS transistor in the detection target net list with a sub-circuit according to a threshold value and type of the MOS transistor; and a sub-circuit addition step of adding, into the detection target net list, sub-circuit information of the sub-circuit with which the MOS transistor is replaced.

Therefore, whether the stationary-state through current detection target circuit is an analog CMOS circuit or a CMOS logic circuit, it is possible to, with a computer, reliably detect a position where through current might flow in stationary state, and fix a gate terminal of a MOS transistor in which through current might flow, to a voltage between the power supply and the reference voltage. Furthermore, with respect to the net list converted by the program, resistor elements are added in the net list while maintaining the net list before the conversion, whereby the construction of the detection target circuit can easily be known from the net list after the net list conversion.

Further, a program of the present invention is a net list conversion program for making a computer execute a net list conversion process for a net list to be subjected to detection of through current in a stationary state, and the program comprises: a net list designation step of designating the net list; a first net extraction step of extracting a net connected to a gate terminal of a MOS transistor from the detection target net list, and storing the extracted net in an extracted net database which is provided for each of MOS transistors having different threshold values; a second net extraction step of extracting a net connected to an input terminal of a sub-circuit from the detection target net list, and storing the extracted not in an extracted net database which is provided for each of the MOS transistors having different threshold values; and a resistor insertion step of inserting a resistor element having a unique resistor element name, between the net extracted in the first net extraction step and the second net extraction step and a power supply, and between the extracted net and a reference voltage, in the detection target net list, on the basis of the extracted net database that is provided for each of the MOS transistors having different threshold values.

Therefore, whether the stationary-state through current detection target circuit is an analog CMOS circuit or a CMOS logic circuit, it is possible to, with a computer, reliably detect a position where through current might flow in stationary state, and fix a gate terminal of a MOS transistor in which through current might flow, to a voltage between the power supply and the reference voltage. Furthermore, even when a sub-circuit is included in the net list, it is possible to reliably detect, with a computer, a position where through current might be detected, in the sub-circuit.

Further, a program of the present invention is a stationary through current detection program for making a computer execute a stationary through current detection process for a net list to be subjected to detection of through current in a stationary state, and the program comprises: a net list conversion step of converting a net list to be subjected to detection of through current in a stationary state, by using a net list conversion method according to any of Claims 1, 10, and 14; a DC analysis step of subjecting a post-conversion net list obtained in the net list conversion step to DC analysis to obtain a DC analysis result; and a transistor search step of searching for a MOS transistor in which through current might occur, in the detection target net list, on the basis of the DC analysis result obtained in the DC analysis step.

Therefore, whether the stationary-state through current detection target circuit is an analog CMOS circuit or a CMOS logic circuit, it is possible to easily detect, by a computer, a position where through current might occur, which position is difficult to detect by the conventional DC analysis, when performing stationary-state through current detection.

Further, a program of the present invention is a stationary through current detection program for making a computer execute a stationary through current detection process for a net list to be subjected to detection of through current in a stationary state, and the program comprises: a net list conversion step of converting a net list to be subjected to detection of through current in a stationary state, by using a net list conversion method according to any of Claims 9, 11, and 17; a DC analysis step of subjecting a post-conversion net list obtained in the net list conversion step to DC analysis to obtain a DC analysis result; a transistor search step of searching for a MOS transistor in which through current might occur, in the detection target net list, on the basis of the DC analysis result obtained in the DC analysis step; and a total through current calculation step of calculating total through current in the detection target net list.

Therefore, whether the stationary-state through current detection target circuit is an analog CMOS circuit or a CMOS logic circuit, it is possible to easily detect, with a computer, a position where through current might occur, which position is difficult to detect by the conventional DC analysis, when performing stationary-state through current detection, and further, it is possible to calculate, with a computer, through current that occurs in the through current detection target circuit.

Further, a program of the present invention is a stationary through current detection program for making a computer execute a stationary through current detection process for a net list to be subjected to detection of through current in a stationary state, and the program comprises: a net list conversion step of converting a net list to be subjected to detection of through current in a stationary state, by using a net list conversion method according to any of Claims 1, 10, and 14; and a histogram formation step of subjecting a post-conversion net list obtained in the net list conversion step to DC analysis, and forming a histogram relating to through currents |Ids| in MOS transistors in the detection target net list on the basis of the DC analysis result.

Therefore, a histogram relating to through current that occurs in the stationary-state through current detection target circuit can be create with a computer, and the histogram makes it possible to visually detect a position where through current might occur in the through current detection target circuit.

### BRIEF DESCRIPTION OF THE DRAWINGS

FIG. 1 is a block diagram illustrating the construction of a net list conversion apparatus according to a first embodiment of the present invention.

FIG. 2 is a diagram illustrating a series of steps of a net list conversion process by the net list conversion apparatus according to the first embodiment.

FIG. 3 is a diagram illustrating specific steps of a net extraction process included in the net list conversion process by the net list conversion apparatus according to the first embodiment.

FIG. 4 is a diagram illustrating specific steps of a resistor insertion process included in the net list conversion process by the net list conversion apparatus according to the first embodiment.

FIG. 5(a) is a diagram showing a net list of a target circuit to be subjected to net list conversion by the net list conversion apparatus according to the first embodiment.

FIG. 5(b) is a diagram illustrating an extracted net database for nets extracted by a net extraction unit of the net list conversion apparatus according to the first embodiment, and a resistor element name database.

FIG. 5(c) is a diagram illustrating a post-conversion net list which is obtained in the net list conversion process by the net list conversion apparatus according to the first embodiment, and a resistor element name database obtained after the conversion process.

FIG. 6 is a circuit diagram of the post-conversion net list that is obtained in the net list conversion process by the net list conversion apparatus according to the first embodiment.

FIG. 7 is a block diagram illustrating a net list conversion apparatus according to a second embodiment of the present invention.

FIG. 8 is a diagram illustrating a series of steps of a net list conversion process by the net list conversion apparatus according to the second embodiment.

FIG. 9 is a diagram illustrating specific steps of an overlapping net deletion process included in the net list conversion process by the net list conversion apparatus according to the second embodiment.

FIG. 10(a) is a diagram illustrating an extracted net database for nets extracted by a net extraction unit of the net list conversion apparatus according to the second embodiment, and a resistor element name database.

FIG. 10(b) is a diagram illustrating the extracted net database after processed by an overlapping net deletion unit of the net list conversion apparatus according to the second embodiment.

FIG. 10(c) is a diagram illustrating a post-conversion net list which is obtained in the net list conversion process by the net list conversion apparatus according to the second embodiment, and a resistor element name database obtained after the conversion process.

FIG. 11 is a circuit diagram of the post-conversion net list that is obtained in the net list conversion process by the net list conversion apparatus according to the second embodiment.

FIG. 12 is a block diagram illustrating the construction of a net list conversion apparatus according to a third embodiment of the present invention.

FIG. 13 is a diagram illustrating a series of steps of a net list conversion process by the net list conversion apparatus according to the third embodiment.

FIG. 14 is a diagram illustrating specific steps of an extracted net number counting process included in the net list conversion process by the net list conversion apparatus according to the third embodiment.

FIG. 15 is a diagram illustrating an extracted net number holding unit for holding the number of extracted nets, which is obtained by an extracted net number counting unit of the net list conversion apparatus according to the third embodiment.

FIG. 16 is a block diagram illustrating the construction of a net list conversion apparatus according to the fourth embodiment.

FIG. 17 is a diagram illustrating a series of steps of a net list conversion process by the net list conversion apparatus according to the fourth embodiment.

FIG. 18 is a diagram illustrating specific steps of a transistor replacement process included in the net list conversion process by the net list conversion apparatus according to the fourth embodiment.

FIG. 19 is a diagram illustrating specific steps of a sub-circuit addition process included in the net list conversion process by the net lit conversion apparatus according to the fourth embodiment.

FIG. 20 is a diagram illustrating a post-conversion net list which is obtained in the net list conversion process by the net list conversion apparatus according to the fourth embodiment, and a replaced transistor number holding unit after the conversion process.

FIG. 21 is a circuit diagram of the post-conversion net list obtained in the net list conversion process by the net list conversion apparatus according to the fourth embodiment.

FIG. 22 is a block diagram illustrating the construction of a net list conversion apparatus according to a fifth embodiment of the present invention.

FIG. 23 is a diagram illustrating a series of steps in a net list conversion process by the net list conversion apparatus according to the fifth embodiment.

FIG. 24 is a diagram illustrating specific steps of a second net extraction process included in the net list conversion process by the net list conversion apparatus according to the fifth embodiment.

FIG. 25 is a diagram illustrating specific steps of a resistor insertion process included in the net list conversion process by the net list conversion apparatus according to the fifth embodiment.

FIG. 26(a) is a diagram showing a net list of a target circuit to be subjected to net list conversion by the net list conversion apparatus according to the fifth embodiment.

FIG. 26(b) is a diagram illustrating an extracted net database for nets extracted by a first net extraction unit of the net list conversion apparatus according to the fifth embodiment, and a resistor element name database.

FIG. 26(c) is a diagram showing a sub-circuit database of the net list conversion apparatus according to the fifth embodiment, and an extracted net database for nets extracted by a second net extraction unit.

FIG. 26(d) is a diagram showing the extracted net database after processed by an overlapping net deletion unit of the net list conversion apparatus according to the fifth embodiment.

FIG. 26(e) is a diagram showing an extracted net number holding unit of the net list conversion apparatus according to the fifth embodiment.

FIG. 26(f) is a diagram illustrating a post-conversion net list obtained in the net list conversion process by the net list conversion apparatus according to the fifth embodiment, and the resistor element name database after the conversion process.

FIG. 27 is a block diagram illustrating the construction of a stationary through current detection apparatus according to a sixth embodiment of the present invention.

FIG. 28 is a diagram illustrating a series of steps of a stationary through current detection process by the stationary through current detection apparatus according to the sixth embodiment.

FIG. 29 is a diagram illustrating specific steps of a transistor search process included in the stationary through current detection process by the stationary through current detection apparatus according to the sixth embodiment.

FIG. 30 is a block diagram illustrating the construction of a stationary through current detection apparatus according to a seventh embodiment of the present invention.

FIG. 31 is a diagram illustrating a series of steps of a stationary through current detection process by the stationary through detection apparatus according to the seventh embodiment.

FIG. 32 is a diagram illustrating specific steps of a total through current calculation process included in the stationary through current detection process by the stationary through current detection apparatus according to the seventh embodiment.

FIG. 33 is a block diagram illustrating the construction of a stationary-state through current detection apparatus according to an eighth embodiment of the present invention.

FIG. 34 is a diagram illustrating a series of steps of a stationary through current detection process by the stationary through current detection apparatus according to the eighth embodiment.

FIG. 35 is a diagram illustrating specific steps of a |IDS| histogram formation process included in the stationary through current detection process by the stationary through current detection apparatus according to the eighth embodiment.

FIG. 36(a) is a diagram illustrating a transistor |IDS| database obtained by the |IDS| histogram formation unit, of the stationary state through current detection apparatus according to the eighth embodiment.

FIG. 36(b) is a diagram illustrating a histogram obtained by the |IDS| histogram formation unit of the stationary through current detection apparatus according to the eighth embodiment of the present invention.

FIG. 37(a) is an example of a circuit for explaining the present invention.

FIG. 37(b) is another example of a circuit for explaining the present invention.

FIG. 38 is an example of a circuit for explaining conventional problems.

### BEST MODE TO EXECUTE THE INVENTION

In the present invention, a net list of a target circuit is converted, and DC analysis simulation is performed on the converted net list, thereby detecting a stationary through current of the target circuit. Accordingly, in the following embodiments of the invention, initially, net list conversion apparatuses will be described with reference to the drawings, and thereafter, stationary through current detection apparatuses using the respective net list conversion apparatuses will be described. It is premised that the net lists described hereinafter are SPICE format net lists.

### Embodiment 1

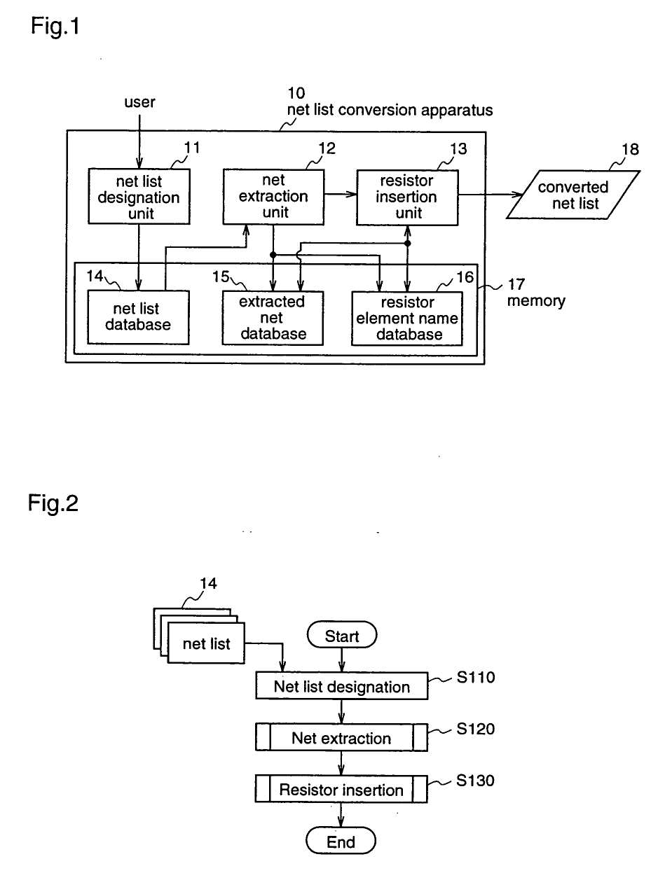

Hereinafter, a net list conversion apparatus according to a first embodiment of the present invention will be described with reference to FIGS. 1 to 6.

Initially, the construction of the net list conversion apparatus 10 according to the first embodiment will be described with reference to FIG. 1. FIG. 1 is a block diagram illustrating the construction of the net list conversion apparatus according to the first embodiment.

In FIG. 1, the net list conversion apparatus 10 comprises a net list designation unit 11, a net extraction unit 12, a resistance insertion unit 13, and a memory 17.

To be specific, the net list designation unit 11 designates a net list of a conversion target circuit to be subjected to detection of through current in a stationary state (hereinafter referred to as “target net list”), from net lists which are previously stored in a net list database 14. The net extraction unit 12 reads the target net list designated by the net list designation unit 11 from the net list database 14, and extracts a net connected to a gate terminal of a MOS transistor, and a name of a resistor element of a resistor existing in the net list, from the read target net list. The resistor insertion unit 13 inserts a resistor element between the net that is connected to the gate terminal of the MOS transistor and extracted from the target net list by the net extraction unit 12, and a power supply that is determined for each threshold value of the MOS transistor, and between the net that is connected to the gate terminal of the MOS transistor and extracted from the target net list by the net extraction unit 12, and a reference voltage. The memory 17 comprises the net list database 14, an extracted net database 15 for holding the net that is connected to the gate terminal of the MOS transistor and extracted by the net extraction unit 12, for each threshold value of the MOS transistor, and a resistor element name database 16 for holding the resistor element name extracted by the net extraction unit 12.

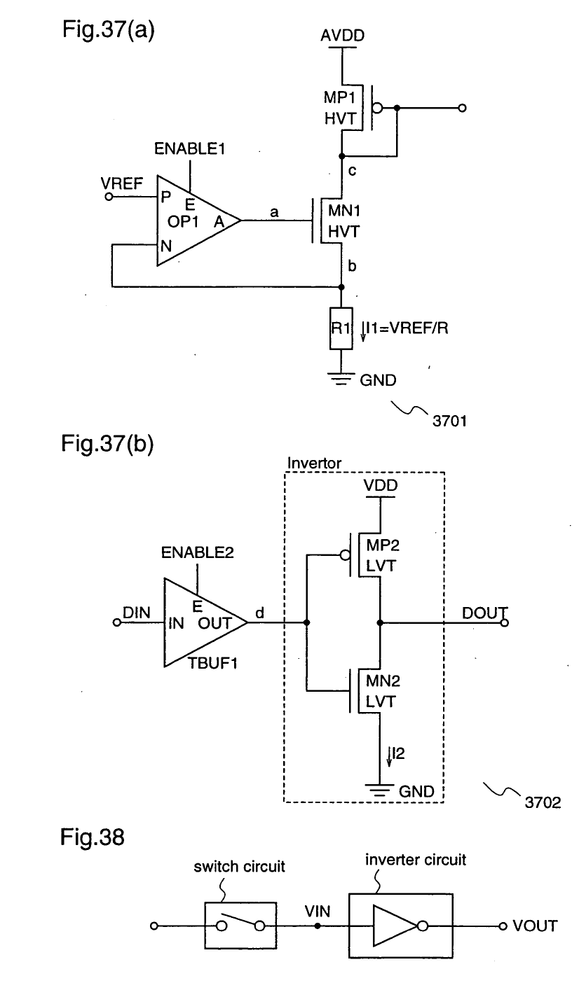

Next, the operation of the net list conversion apparatus 10 according to the first embodiment constructed as mentioned above will be described with reference to FIGS. 2 to 6. The description will be given of a case where the net lists of the circuits shown in FIGS. 37(a) and 37(b) are converted in order to detect stationary through currents in these circuits.

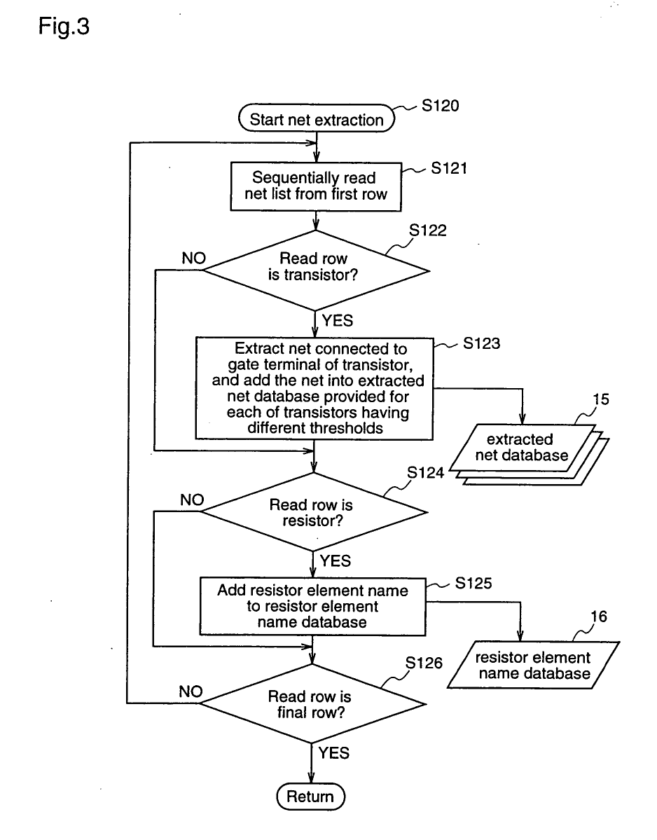

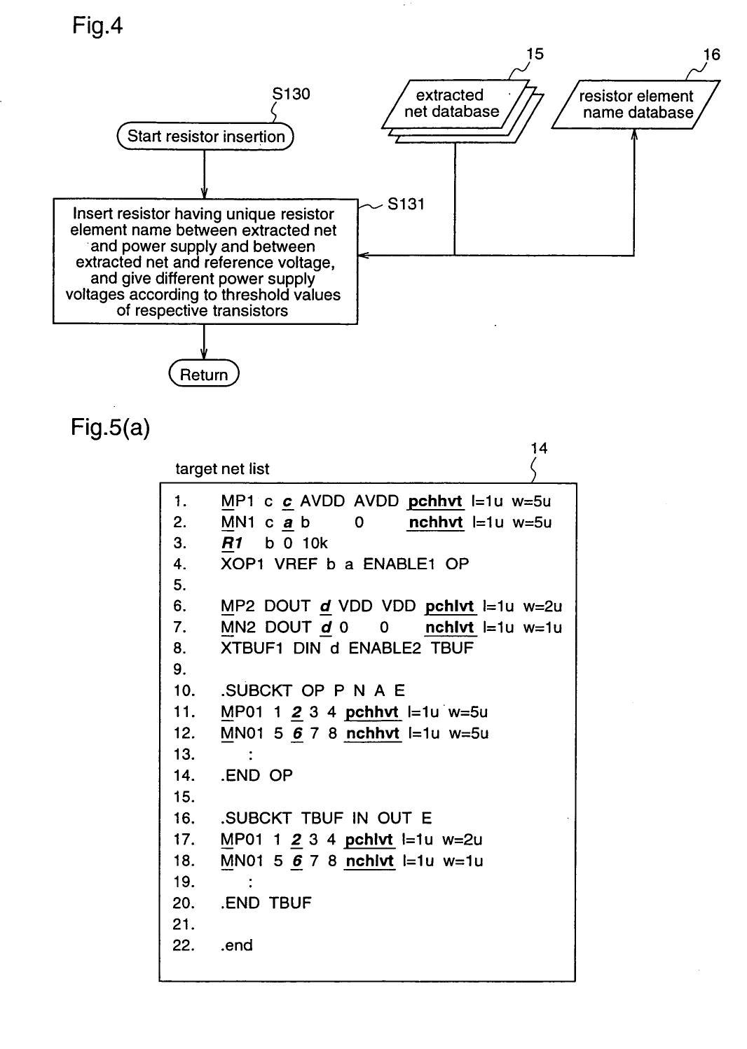

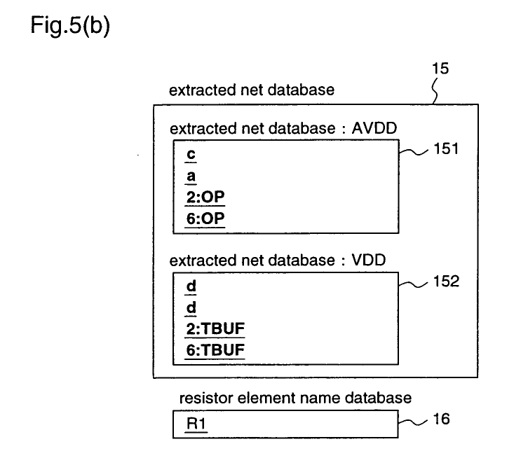

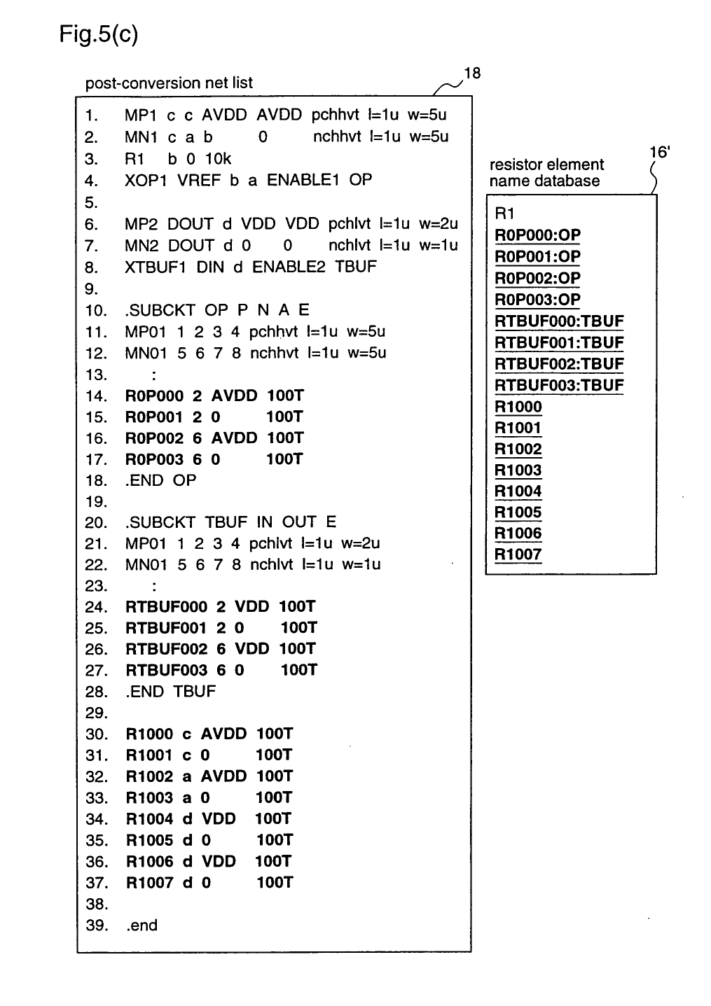

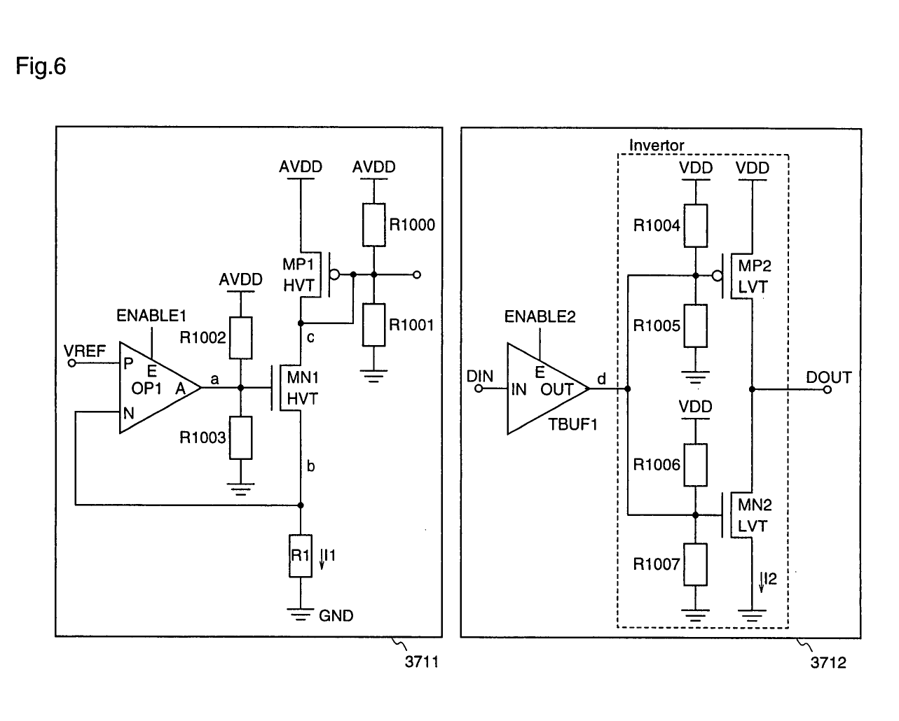

FIG. 2 is a diagram illustrating a series of steps of a net list conversion process performed by the net list conversion apparatus according to the first embodiment. FIG. 3 is a diagram illustrating specific steps of a net extraction process included in the net list conversion process shown in FIG. 2. FIG. 4 is a diagram illustrating specific steps of a resistor insertion process included in the net list conversion process shown in FIG. 2. FIG. 5(a) is a diagram showing a net list of a target circuit (the circuits shown in FIGS. 37(a) and 37(b)) to be subjected to net list conversion by the net list conversion apparatus according to the first embodiment. FIG. 5(b) is a diagram illustrating an extracted net database and a resistor element name database which are extracted by the net extraction unit of the net list conversion apparatus according to the first embodiment. FIG. 5(c) is a diagram illustrating a post-conversion net list which is obtained by subjecting the net list shown in FIG. 5(a) to net list conversion by the net list conversion apparatus according to the first embodiment, and a resistor element name database obtained after the conversion. FIG. 6 is a diagram illustrating the circuits after the net list conversion shown in FIG. 5(c).

Initially, a user designates a target net list to be subjected to stationary through current detection, using the net list designation unit 11 (step S110 in FIG. 2). Next, the net extraction unit 12 performs a net extraction process for extracting nets connected to gate terminals of MOS transistors in the target net list shown in FIG. 5(a) (step S120 in FIG. 2).

Hereinafter, the net extraction process will be described in detail with reference to FIG. 3.

Initially, the target net list shown in FIG. 5(a) which is designated by the net list designation unit 11 is successively read, row by row, starting from the first row (step S121 in FIG. 3). There are cases where one element is described over plural rows in the net list. In this case, it is checked whether the first character in the next row begins with “+” or not. When the first character in the next row begins with “+”, the read row and the next row are successively combined to provide the same function.

Next, it is checked whether the row read in step S121 is a description relating to a MOS transistor or not (step S122 in FIG. 3). In this first embodiment, it is determined whether the read row relates to a MOS transistor or not by checking whether the first character in the read row begins with “M” or not. To be specific, when the first character in the read row begins with “M”, it is determined that the description relates to a MOS transistor, and next step S123 is executed; otherwise, step S124 is executed.

When it is determined in step S122 that the read row relates to a MOS transistor, a threshold value of the MOS transistor is determined from the sixth character string in the read row, i.e., from the model name of the MOS transistor. The reason why the threshold value of the MOS transistor should be determined is as follows. That is, a recent MOS transistor has plural kinds of breakdown voltages on one process, i.e., plural kinds of threshold values on one process. Therefore, it is necessary to supply a power source voltage according to the threshold value of the MOS transistor, for each MOS transistor in the net list.

After determining the threshold value of the MOS transistor in the read row as described above, the third character string in the same row, i.e., a net connected to the gate electrode of the MOS transistor is detected, and the detected net is added to the corresponding extracted net database among the extracted net databases 151˜152 (refer to FIG. 5(b)) which are provided in the extracted net database 15, corresponding to the respective threshold values of the MOS transistor (step S123 in FIG. 3).

Thereafter, it is determined whether the read row is a description relates to a resistor element or not (step S124 in FIG. 3). It is determined whether the read row relates to a resistor element or not by checking whether the first character in the read row begins with “R” or not. To be specific, when the first character in the read row begins with “R”, it is determined that the description relates to a resistor element, and next step S125 is executed; otherwise, step S126 is executed.

When it is determined that the read row relates to a resistor element in step S124, the name of the resistor element is added to the resistor element name database 16 (step S125 in FIG. 3).

Thereafter, it is checked whether the read row is the final row or not (step S126 in FIG. 3), and the processing is ended when it is the final row; otherwise, the processing returns to step S121 to repeat the above-mentioned steps.

Through the above-mentioned processing, the extracted net database 15 and the resistor element name database 16 as shown in FIG. 5(b) can be obtained from the target net list shown in FIG. 5(a). Since each MOS transistor in the target net list has two kinds of threshold values AVDD and VDD, the extracted net database 151 for the threshold value AVDD and the extracted net database 152 for the threshold value VDD exist in the extracted net database 15.

As described above, when it is determined in the net extraction step S126 that the read row is the final row, a resistor insertion process takes place, for inserting a resistor element that connects the net extracted by the net extraction process with the power supply, and a resistor element that connects the extracted net with the reference voltage, into the net list (step S130 in FIG. 2).

Hereinafter, the resistor insertion process will be described in detail with reference to FIG. 4.

Resistors are inserted between all the nets which are extracted for each threshold value of the MOS transistor by the net extraction unit 12 and stored in the extracted net database 15, and the power supply voltage which is determined for each threshold value of the MOS transistor, and between all the nets stored in the extracted net database 15 and the reference voltage (step S131 in FIG. 4). At this time, unique resistor element names are given to the respective resistor elements to be inserted in the target net list, by searching through the resistor element name database 16. For example, when the resistor elements in the resistor element name database 16 are arranged in lexicographical order, a numeral “000” is added to the end of the largest (closest to the final page of the lexicon) resistor element name. Every time a resistor element is added in step S131, the numeral added to the end of the resistor element name is incremented by “1”, thereby obtaining unique resistor element names. Then, the name of the resistor element inserted in step S131 is added to the resistor element name database 16. By repeating this process, the net list is converted. The resistors to be inserted in the net list should have high resistances (several GOhm˜several hundreds TOhm) which do not affect the operations of other circuits.

Through the above-mentioned processing, the post-conversion net list 18 and the resistor element name database 16′ in which the resistors added to the net list shown in FIG. 5(c) are obtained from the target net list shown in FIG. 5(a).

Next, the operation of the net list conversion apparatus 10 according to the first embodiment will be described in more detail with reference to the example of the net list shown in FIG. 5.

Initially, the user designates the target net list shown in FIG. 5(a) using the net list designation unit 11. Next, the net extraction unit 12 extracts a target net to be subjected to conversion, from the target net list. At this time, the net extraction unit 12 reads the target net list shown in FIG. 5(a), row by row, starting from the first row. Then, it is checked whether the first character in the read row begins with “M” or not (underlined portions in FIG. 5(a)) to determine whether the read row is a description relating to a MOS transistor or not. In FIG. 5(a), it is determined that the 1st, 2nd, 6th, 7th, 11th, 12th, 17th, and 18th rows are descriptions relating to MOS transistors.

Then, the threshold value of the MOS transistor is determined from the sixth character string in the read row (underlined bold letter portions in FIG. 5(a)), i.e., from the model name of the MOS transistor. In FIG. 5(a), it is determined that the MOS transistor has a high threshold value (HVT) when the sixth character string is pchhvt or nchhvt, while it is determined that the MOS transistor has a low threshold value (LVT) when the sixth character string is pchlvt or nchlvt.

Simultaneously, the third character string in the read row (underlined bold diagonal letter portions in the 1st, 2nd, 6th, 7th, 11th, 12th, 17th and 18th in FIG. 5(a)), i.e., a net connected to the gate electrode of the MOS transistor is detected, and the detected net is added to the extracted net database 15 that is provided for each threshold value of the MOS transistor. The extracted net database:AVDD 151 shown in FIG. 5(b) corresponds to the extracted net database of the HVTMOS transistor in the target net list shown in FIG. 5(a), and the extracted net database:VDD 152 shown in FIG. 5(b) corresponds to the extracted net database of the LVTMOS transistor in the target net list shown in FIG. 5(a). Further, character strings after semicolons described in FIG. 5(b) indicate hierarchical structure in the net list.

Next, it is determined whether the read row is a description relating to a resistor element or not by checking whether the first character in the read row begins with “R” or not. In the net list shown in FIG. 5(a), it is determined that the 3rd row is a description relating to a resistor element.

Then, the first character string in the read row (underlined bold diagonal letter portions in the 3rd row in FIG. 5(a)), i.e., the name of the resistor element, is added to the resistor element name database 16. In FIG. 5(a), the resistor element name database 16 shown in FIG. 5(b) corresponds to it.

When the target net list shown in FIG. 5(a) is read up to the final row, the resistor insertion unit 13 inserts, in the target net list, a resistor element connecting the net extracted by the net extraction unit 12 with the power supply and a resistor element connecting the net extracted by the net extraction unit 12 with the reference voltage. In the case of the extracted net database:AVDD 151 shown in FIG. 5(b), resistor elements are inserted between the nets entered in the database and the power supply AVDD, and between the nets entered in the database and the reference voltage. In the case of the extracted net database:VDD 152, resistor elements are inserted between the nets entered in the database and the power supply VDD, and between the nets entered in the database and the reference voltage. To be specific, the 14th˜17th rows, the 24th˜27th rows, and the 30th˜37th rows in the post-conversion net list 18 shown in FIG. 5(c) correspond to the resistor elements inserted into the target net list. At this time, unique resistor element names are given to the respective inserted resistor elements by searching through the resistor element name database 16. Further, the names of the resistor elements inserted in the target net list as mentioned above are successively added to the resistor element name database 16 (the resistor element name database 16′ in FIG. 5(c)). By repeating this process, the net list of the target circuit is converted.

The circuit diagram of the post-conversion net list obtained by the above-mentioned net list conversion is the circuit 3711 or 3712 shown in FIG. 6. Although, in FIG. 6, the resistors inserted in the OP1 and the TBUF1 are not shown for simplification, actually four resistors are inserted in each of the OP1 and the TBUF1.

As described above, according to the first embodiment, the net list of the target circuit is converted so as to insert the resistors to the gate terminals of the MOS transistors in the target circuit to be subjected to conversion. Therefore, whether the target circuit is an analog MOS circuit or a CMOS logic circuit, when the gate terminal of the MOS transistor is unfixed, the inserted resistor elements serve as a pull-up resistor and a pull-down resistor between the gate terminal of the MOS transistor and the power supply and between the gate terminal of the MOS transistor and the reference voltage. Consequently, the gate terminal of the MOS transistor in which through current might flow in a stationary state can be fixed to a voltage between the power supply voltage and the reference voltage, which enables reliable detection of through current that cannot be easily detected by the conventional DC analysis simulation, in a stationary through current detection apparatus to be described later.

Further, according to the first embodiment, a MOS transistor is detected from the target net list, and a net connected to the gate terminal of the MOS transistor is extracted, and a resistor is inserted in the net. Therefore, it is possible to reliably detect a transistor in which through current might occur, in the target circuit. Consequently, it is possible to reliably detect through current which cannot be easily detected by the conventional DC analysis simulation, in the stationary through current detection apparatus described later.

### Embodiment 2

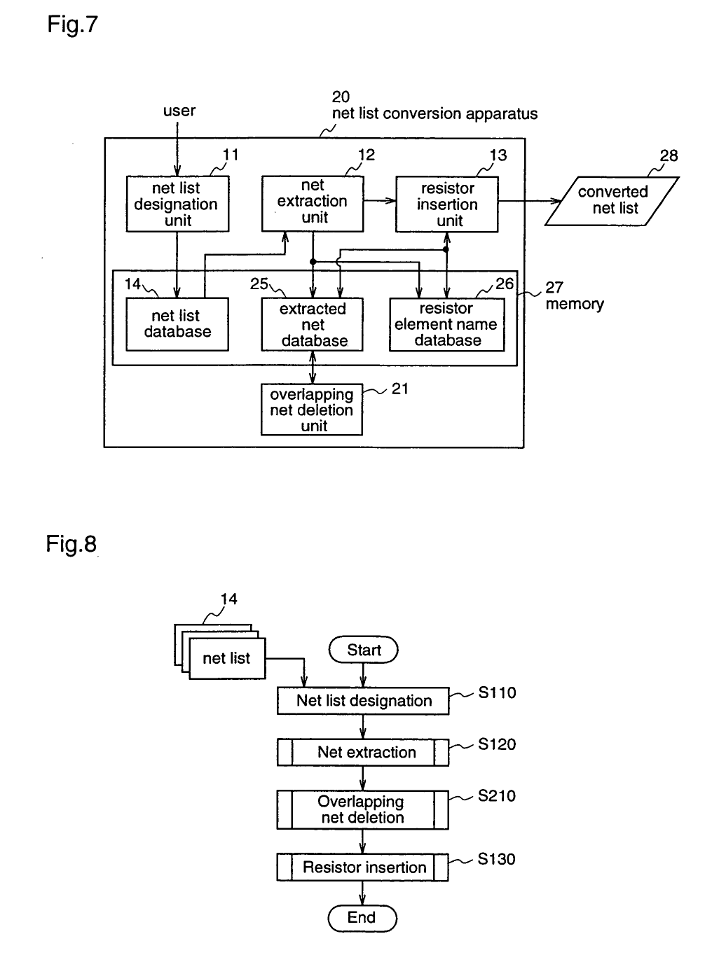

Hereinafter, a net list conversion apparatus according to a second embodiment will be described with reference to FIGS. 7˜11.

In the first embodiment, all the gate terminals of MOS transistors which may cause through currents are extracted from the net list of the target circuit by the net extraction unit, and resistors are inserted by the resistor insertion unit so as to connect the extracted nets with the power supply and connect the extracted nets with the reference voltage. In this second embodiment, an overlapping net deletion unit is further provided to delete overlapping nets from among the nets extracted by the net extraction unit.

Initially, the construction of the net list conversion apparatus 20 according to the second embodiment will be described with reference to FIG. 7. FIG. 7 is a block diagram illustrating the net list conversion apparatus 20 according to the second embodiment.

In FIG. 7, the net list conversion apparatus 20 comprises a net list designation unit 11, a net extraction unit 12, a resistor insertion unit 13, an overlapping net deletion unit 21, and a memory 27 containing a net list database 14, an extracted net database 25, and a resistor element name database 26. To be specific, the overlapping net deletion unit 21 deletes overlapping nets from among the nets extracted by the net extraction unit 12, and outputs a new extracted net database 25. Since other constituents are identical to those described for the first embodiment, repeated description is not necessary.

Next, the operation of the net list conversion apparatus 20 according to the second embodiment having the above-mentioned construction will be described with reference to FIGS. 8˜11. The description will be given of the case where the net lists of the circuits shown in FIGS. 37(a) and 37(b) (the target net list shown in FIG. 5(a)) are to be converted.

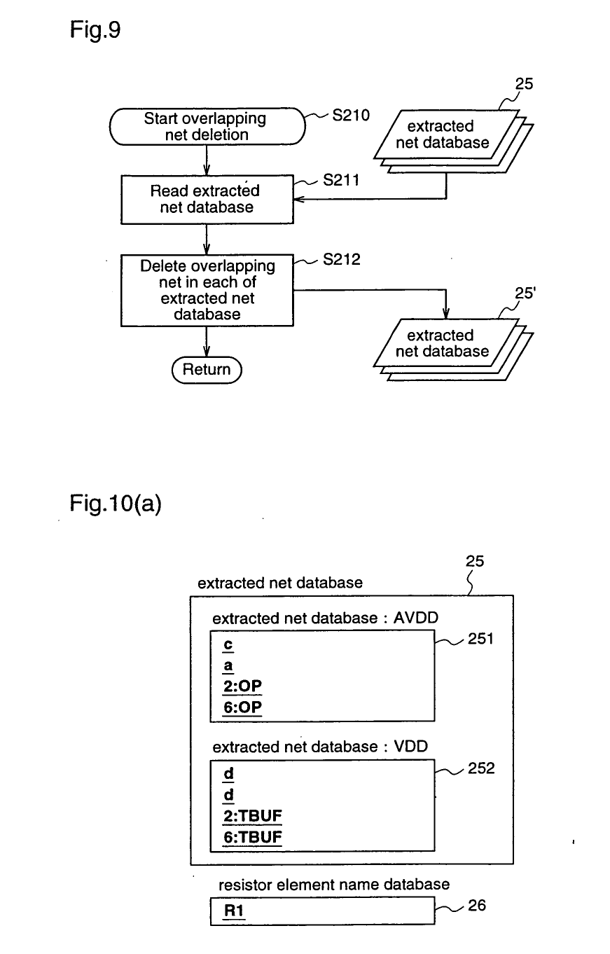

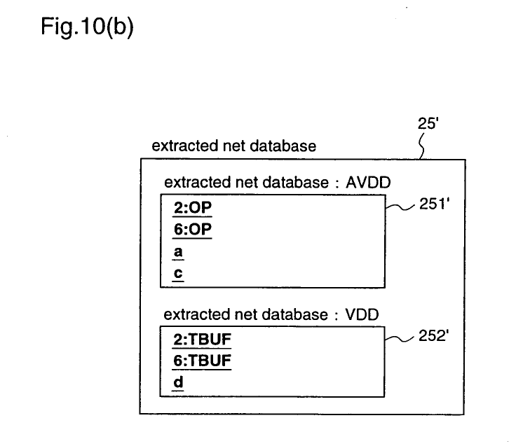

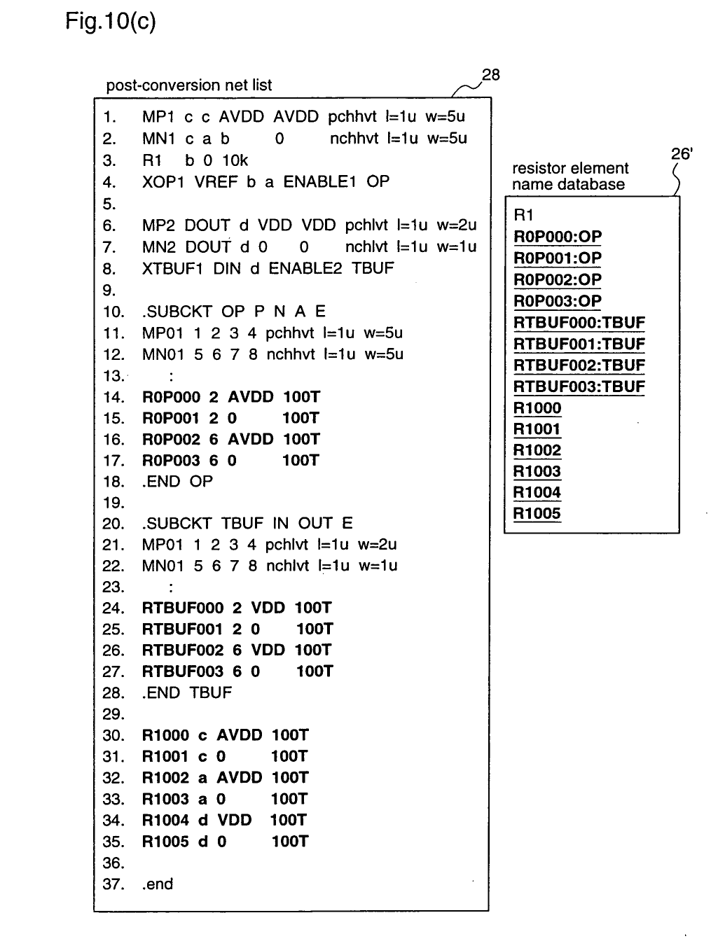

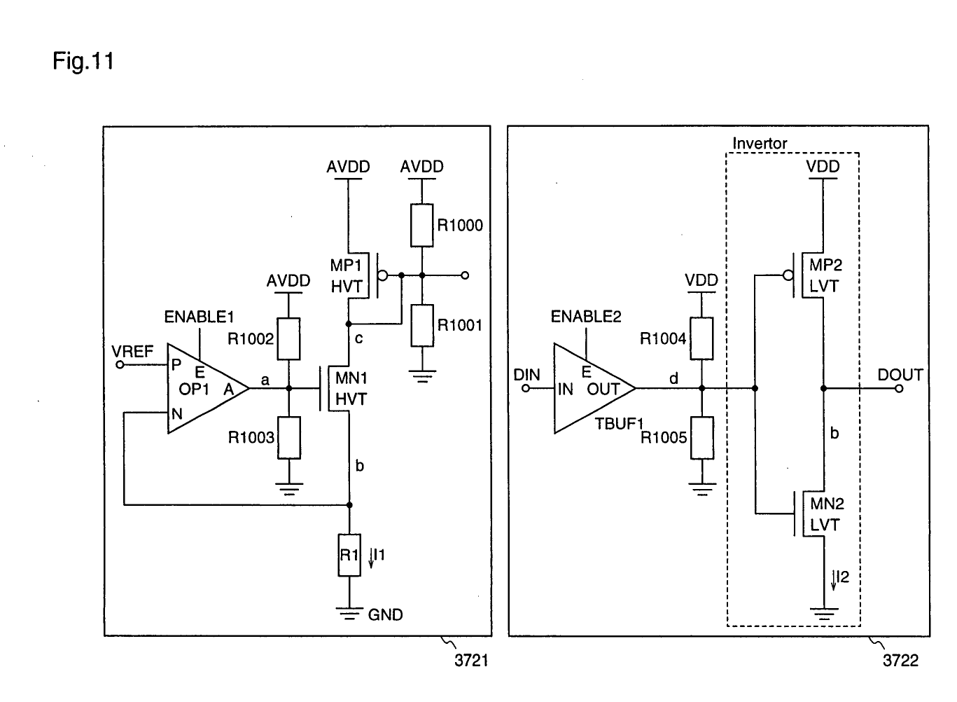

FIG. 8 is a diagram illustrating a series of steps of a net list conversion process by the net list conversion apparatus according to the second embodiment. FIG. 9 is a diagram illustrating specific steps of an overlapping net deletion process included in the net list conversion process shown in FIG. 8. FIG. 10(a) is a diagram illustrating an extracted net database and a resistor element name database which are extracted by the net extraction unit of the net list conversion apparatus according to the second embodiment. FIG. 10(b) is a diagram illustrating the contents of a post-conversion net list that is obtained by converting the net list shown in FIG. 5(a) as well as the contents of the resistor element name database obtained after the net list conversion. FIG. 11 is a circuit diagram of the post-conversion net list shown in FIG. 10(c).

Initially, a user designates a target net list to be subjected to detection of through current in stationary state by using the net list designation unit 11 (step S110 in FIG. 8). Next, the net extraction unit 12 performs a net extraction process of extracting nets connected to the gate terminals of MOS transistors in the target net list shown in FIG. 5(a) (step S120 in FIG. 8). Since the detail of this process is identical to that described for the first embodiment using FIG. 3, repeated description is not necessary.

Thereafter, an overlapping net in the extracted net database 25 is deleted by the overlapping net deletion unit 21 (step S210 in FIG. 8).

Hereinafter, the overlapping net deletion process will be described in detail with reference to FIG. 9.

Initially, the nets extracted by the net extraction unit 12 are successively read from the extracted net database 25 which is provided for each threshold value of the MOS transistor (step S211 in FIG. 9). Next, the nets read from the extracted net database 25 are rearranged in lexicographical order, and the extracted net database rearranged in lexicographical order is searched from the first row. When a net indicated in the search target row overlaps a net indicated in a row before or after the target row, the overlapping net is deleted (step S212 in FIG. 9). When the above-mentioned searching of the extracted net database is ended, a new extracted net database 25′ in which overlapping portions in the extracted net database 25 are deleted is output.

After the new extracted net database 25′ in which overlapping nets are deleted is output from the overlapping net deletion unit 21, a resistor insertion process is carried out, that is, a resistor element is inserted between the extracted net from which the overlapping net is deleted and the power supply, and between the extracted net from which the overlapping net is deleted and the reference voltage (step S130 in FIG. 8). Since the detail of this process is identical to that described for the first embodiment using FIG. 4, repeated description is not necessary.

Through the above-mentioned processes, it is possible to obtain, from the target net list shown in FIG. 5(a), the post-conversion net list 28 shown in FIG. 10(c) and the resistor element name database 26′ in which the resistors added to the target net list are added.

Next, the operation of the net list conversion apparatus 20 according to the second embodiment will be described in more detail using the net lists shown in FIG. 5(a) and FIG. 10.

Initially, the user designates the target net list shown in FIG. 5(a) using the net list designation unit 11. Next, the net extraction unit 12 extracts a net as a conversion target from the target net list. At this time, the net extraction unit 12 checks whether the first character in the read row begins with “M” or not (underlined portions in FIG. 5(a)) to determine whether the read row is a description relating to a MOS transistor or not. In FIG. 5(a), it is determined that the 1st, 2nd, 6th, 7th, 11th, 12th, 17th, and 18th rows are descriptions relating to MOS transistors.

Then, the threshold value of the MOS transistor is determined from the sixth character string in the read row (underlined bold letter portions in the 1st, 2nd, 6th, 7th, 11th, 12th, 17th and 18th rows in FIG. 5(a)), i.e., from the model name of the MOS transistor. In FIG. 5(a), it is determined that the MOS transistor has a high threshold value (HVT) when the sixth character string is pchhvt or nchhvt, while it has a low threshold value (LVT) when the sixth character string is pchlvt or nchlvt.

Simultaneously, the third character string in the read row (underlined bold diagonal letter portions in the 1st, 2nd, 6th, 7th, 11th, 12th, 17th and 18th in FIG. 5(a)), i.e., a net connected to the gate electrode of the MOS transistor is detected, and the detected net is added to the extracted net database 25 which is provided for each threshold value of the MOS transistor. The extracted net database:AVDD 251 shown in FIG. 10(a) corresponds to the extracted net database of the HVTMOS transistor in the target net list shown in FIG. 5(a), and the extracted net database:VDD 252 shown in FIG. 10(a) corresponds to the extracted net database of the LVTMOS transistor. Further, character strings after semicolons described in FIG. 10(a) indicate hierarchical structure in the net list.

Next, it is determined whether the read row is a description relating to a resistor element or not by checking whether the first character in the read row begins with “R” or not (underlined portion in the third row in FIG. 5(a)). In the net list shown in FIG. 5(a), it is determined that the 3rd row is a description relating to a resistor element.

Then, the first character string in the read row (underlined bold diagonal letter portion in the third row in FIG. 5(a)), i.e., the resistor element name of the resistor element, is added to the resistor element name database 16. In FIG. 5(a), the resistor element name database 26 corresponds thereto.

When the target net list shown in FIG. 5(a) is read up to the last row, the overlapping net deletion unit 21 successively reads the extracted net databases 251 and 252 in the extracted net database 25, which correspond to the respective threshold values, and rearranges the read rows in lexicographical order, and thereafter, deletes overlapping nets. For example, in the extracted net list data 25 shown in FIG. 10(a), since a net d in the extracted net database:VDD 252 overlaps, this overlapping is resolved. After deleting the overlapping net by the overlapping net deletion unit 21, a new extracted net database 25′ is obtained. The extracted net database:AVDD 251′ and the extracted net database:VDD 252′ shown in FIG. 10(b) correspond to the extracted net databases corresponding to the respective threshold values after deletion of the overlapping net.

Thereafter, the resistor insertion unit 13 inserts, in the target net list, resistor elements connecting the extracted nets after the deletion of the overlapping net with the power supply and resistor elements connecting the extracted nets after the deletion of the overlapping nets with the reference voltage. For example, the 14th˜17th, 24th˜27th, and 30th˜35th in the post-conversion net list 28 shown in FIG. 10(c) correspond to the resistor elements inserted in the target net list. At this time, unique resistor element names are given to the respective resistor elements inserted, by searching through the resistor element name database 26. Further, the names of the resistor elements inserted in the target net list as described above are successively added to the resistor element name database 26 (the resistor element name database 26′ shown in FIG. 10(c)). By repeating this operation, the net list of the target circuit is converted.

A circuit diagram of the post-conversion net list obtained by the net list conversion process is shown by the circuit 3721 or 3722 shown in FIG. 11. As is evident from FIG. 11, in the net list conversion process performed by the net list conversion apparatus 20 according to the second embodiment, the number of resistors inserted in the circuit 3722 is reduced as compared with that in the net list conversion process performed by the net list conversion apparatus 10 of the first embodiment (refer to the circuit 3712 shown in FIG. 6). In FIG. 11, for simplification, resistors to be inserted in the OP1 and the TBUF1 are not shown, but actually four resistors are inserted in each of the OP1 and the TBUF1.

As described above, according to the first embodiment, the net list of the target circuit is converted so as to insert the resistors to the gate terminals of the MOS transistors in the target circuit to be subjected to conversion. Therefore, whether the target circuit is an analog MOS circuit or a CMOS logic circuit, when the gate terminal of the MOS transistor is unfixed, the inserted resistor elements serve as a pull-up resistor and a pull-down resistor between the gate terminal of the MOS transistor and the power supply and between the gate terminal of the MOS transistor and the reference voltage. Consequently, the gate terminal of the MOS transistor in which through current might flow in a stationary state can be fixed to a voltage between the power supply voltage and the reference voltage, which enables reliable detection of through current that cannot be easily detected by the conventional DC analysis simulation, in a stationary through current detection apparatus to be described later.

Furthermore, according to the second embodiment, the net extraction unit 12 detects MOS transistors from the target net list, and extracts nets connected to the gate terminals of the MOS transistors. Then, the overlapping net deletion unit 21 deletes overlapping nets from among the extracted nets, and thereafter, resistors are inserted into the nets. Therefore, transistors in the target circuit, which might cause through current, can be reliably detected, whereby through current that cannot be easily detected by the conventional DC analysis simulation can be reliably detected in the stationary through current detection apparatus to be described later. Furthermore, the number of resistor elements to be added to the net list can be minimized, whereby the analysis time in the stationary through current detection apparatus to be described later can be reduced.

In this second embodiment, the net extraction unit 12 extracts, from the net list, the nets connected to the gate terminals of the MOS transistors are connected, and stores the nets in the extracted net database 25, and thereafter, the overlapping net deletion unit 21 reads the extracted net database 25 and deletes overlapping nets. However, simultaneously with extraction of each net connected to the gate terminal of the MOS transistor by the net extraction unit 12, the overlapping net deletion unit 21 may check as to whether the extracted net overlaps a net stored in the extracted net database 25 or not, and when there is no overlapping net, the extracted net is stored in the extracted net database 25. When there is an overlapping net, the extracted net is deleted. Thereby, the processing time for the net conversion process can be reduced.

### Embodiment 3

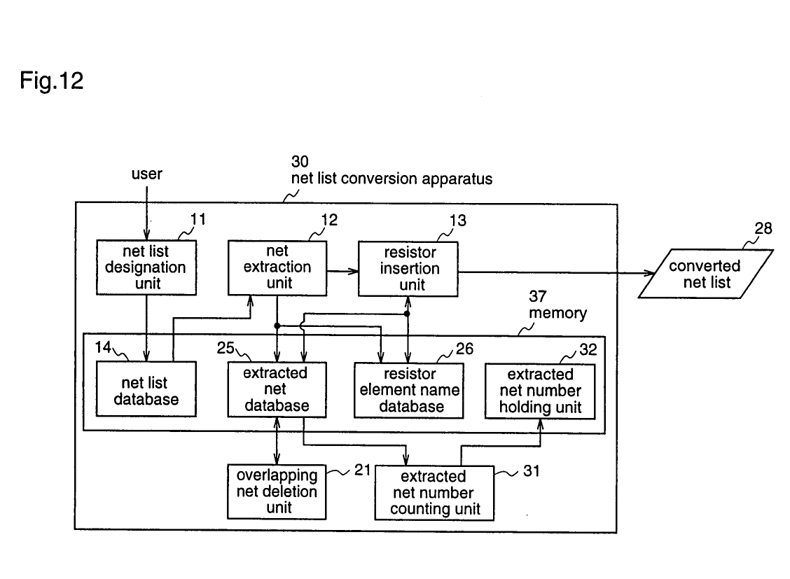

Hereinafter, a net list conversion apparatus according to a third embodiment of the present invention will be described with reference to FIGS. 12˜15.

In the above-mentioned second embodiment, the net extraction unit extracts, from the net list of the target circuit, the gate terminals of MOS transistors in which through current might occur, and the overlapping net deletion unit deletes the overlapping nets from among the extracted nets, and thereafter, the resistor insertion unit inserts the resistors to connect the extracted nets with the power supply and connect the extracted nets with the reference voltage. This third embodiment is further provided with an extracted net number counting unit for counting the number of the extracted nets after deletion of the overlapping nets by the overlapping net deletion unit.

Initially, the construction of the net list conversion apparatus according to the third embodiment will be described with reference to FIG. 12. FIG. 12 is a block diagram illustrating the construction of the net list conversion apparatus according to the third embodiment.

With reference to FIG. 12, the net list conversion apparatus 30 comprises a net list designation unit 11, a net extraction unit 12, an overlapping net deletion unit 21, an extracted net number counting unit 31, a resistor insertion unit 13, and a memory 37 including a net list database 14, an extracted net database 25, a resistor element name database 26, and an extracted net number holding unit 32.

More specifically, the extracted net number counting unit 31 reads the nets stored in the extracted net database 25 which is provided for each threshold value of a MOS transistor, and counts the number of extracted nets after deletion of overlapping nets by the overlapping net deletion unit 21. The extracted net number holding unit 32 in the memory 37 holds the number of extracted nets counted by the extracted net number counting unit 31. Since other constituents are identical to those of the second embodiment, repeated description is not necessary.

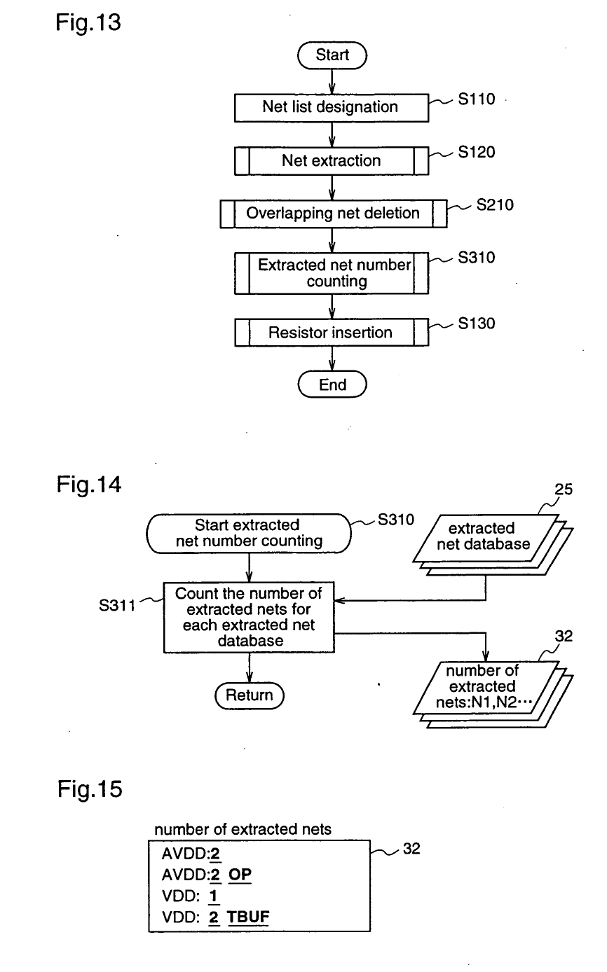

Next, the operation of the net list conversion apparatus 30 according to the third embodiment having the above-mentioned construction will be described with reference to FIGS. 13˜15. Hereinafter, a description will be given of the case where the net lists of the circuits shown in FIGS. 37(a) and 37(b) (the target net list shown in FIG. 5(a)) are to be converted.

FIG. 13 is a diagram illustrating a series of steps of a net list conversion process by the net list conversion apparatus according to the third embodiment. FIG. 14 is a diagram illustrating specific steps of an extracted nit number counting process included in the net list conversion process shown in FIG. 13. FIG. 15 is a diagram illustrating the contents of the extracted net number holding unit, which is extracted by the extracted net number counting unit of the net list conversion apparatus according to the third embodiment.

Initially, a user designates a target net list to be subjected to detection of through current in a stationary state by using the net list designation unit 11 (step S110 in FIG. 13). Next, the net extraction unit 12 performs a net extraction process of extracting nets connected to the gate terminals of MOS transistors in the target net list shown in FIG. 5(a) (step S120 in FIG. 13). Since the detail of this process is identical to that described for the first embodiment using FIG. 3, repeated description is not necessary.

Thereafter, the overlapping net deletion unit 21 reads the nets stored in the extracted net database 25, and deletes overlapping nets, and thereafter, the remaining nets are again outputted to the extracted net database 25 (step S210 in FIG. 13). Since the detail of this process is identical to that described for the second embodiment using FIG. 9, repeated description is not necessary.

Thereafter, the extracted net number counter unit 31 reads the nets stored in the extracted net database 25, and counts the number of nets after deletion of overlapping nets (step S310 in FIG. 13).

Hereinafter, the extracted net number counting process will be described in detail using FIG. 14. The nets stored in the extracted net database 25 which is provided for each threshold value of the MOS transistor are sequentially read from the first row, and the number of extracted nets in each extracted net database are counted, and the count value is stored in the extracted net number holding unit 32 in the memory 37, for each threshold value of the MOS transistor (step S311 in FIG. 14).

After the above-mentioned extracted net number counting process, i.e., after the extracted net number counting unit 31 counts the number of extracted nets after deletion of overlapping nets and then the count value is stored in the extracted net number holding unit 32 for each threshold value of the MOS transistor, a resistor insertion process is carried out, i.e., the resistor insertion unit 13 inserts, in the target net list, resistor elements connecting the respective extracted nets from which overlapping nets are deleted, with the power supply, and resistor elements connecting the extracted net from which overlapping nets are deleted, with the reference voltage (step S130 in FIG. 13). Since the detail of this process is identical to that described for the first embodiment using FIG. 4, repeated description is not necessary.

Through the above-mentioned processing, the post-conversion net list 28 shown in FIG. 10(c), the resistor element name database 26′ to which the resistors added to the target net list are added, and the extracted net number shown in FIG. 15 are obtained from the target net list shown in FIG. 5(a).

Next, the operation of the net list conversion apparatus 30 according to the third embodiment will be described in more detail, using the net lists shown in FIGS. 5(a), 10, and 15.

Initially, the user designates the target net list shown in FIG. 5(a) using the net list designation unit 11. Next, the net extraction unit 12 extracts target nets to be subjected to conversion from the target net list. At this time, the net extraction unit 12 checks whether the first character in the read row begins with “M” or not (underlined portions in FIG. 5(a)) to determine whether the read row is a description relating to a MOS transistor or not. In FIG. 5(a), it is determined that the 1st, 2nd, 6th, 7th, 11th, 12th, 17th, and 18th rows are descriptions relating to MOS transistors.

Then, the threshold value of the MOS transistor is determined from the sixth character string in the read row (underlined bold letter portions in the 1st, 2nd, 6th, 7th, 11th, 12th, 17th, and 18th rows shown in FIG. 5(a)), from the model name of the MOS transistor. In FIG. 5(a), it is determined that the MOS transistor has a high threshold value (HVT) when the sixth character string is pchhvt or nchhvt, while it is determined that the MOS transistor has a low threshold value (LVT) when the sixth character string is pchlvt or nchlvt.

Simultaneously, the third character string in the read row (underlined bold diagonal letter portions in the 1st, 2nd, 6th, 7th, 11th, 12th, 17th and 18th in FIG. 5(a)), i.e., a net connected to the gate electrode of the MOS transistor, is detected, and the detected net is added to the extracted net database 25 that is provided for each threshold value of the MOS transistor. The extracted net database: AVDD 251 shown in FIG. 10(a) corresponds to the extracted net database of the HVTMOS transistor in the target net list shown in FIG. 5(a), and the extracted net database: VDD 252 shown in FIG. 10(a) corresponds to the extracted net database of the LVTMOS transistor.

Next, it is checked whether the first character in the read row begins with “R” or not (underlined portion in the third row shown in FIG. 5(a)) to determine whether the read row is a description relating to a resistor element or not. In the net list shown in FIG. 5(a), it is determined that the 3rd row is a description relating to a resistor element.

Then, the first character string in the read row (diagonal letters with a bold underline in the 3rd row in FIG. 5(a)), i.e., the name of the resistor element is added to the resistor element name database 16. In FIG. 5(a), the resistor element name database 16 shown in FIG. 10(a) corresponds to it.

When the target net list shown in FIG. 5(a) is read up to the final row, the overlapping net deletion unit 21 successively reads the extracted net databases 251 and 252 corresponding to the respective threshold values in the extracted net database 25, and rearranges the read rows in lexicographical order, and thereafter, deletes overlapping nets. For example, in the extracted net list data 25 shown in FIG. 10(a), since a net d overlaps in the extracted net database:VDD 252, this overlapping is resolved. After the deletion of the overlapping net by the overlapping net deletion unit 21, a new extracted net database 25′ is obtained. An extracted net database:AVDD 251′ and an extracted net database: VDD 252′ shown in FIG. 10(b) correspond to the extracted net databases after deletion of the overlapping net.

Thereafter, the extracted net number counting unit 31 counts the number of nets included in the extracted net database 25. In the extracted net database 25′ shown in FIG. 10(b) that is obtained after deletion of the overlapping net, the number of nets relating to the extracted net data base:AVDD 251′, i.e., the HVTMOS transistor, is “2” in the top level hierarchy, and “2” in the operation amplifier OP hierarchy. On the other hand, the number of nets relating to the extracted net database:VDD 252′, i.e., the LVTMOS transistor, is “1” in the top level hierarchy, and “2” in the Tri State Buffer TBUF hierarchy. The information relating to these numbers of nets are stored in the extracted net number holding unit 32, which is shown in FIG. 15.

Thereafter, the resistor insertion unit 13 inserts, in the target net list, resistor elements for connecting the extracted nets after deletion of the overlapping nets with the power supply, and resistor elements for connecting the extracted nets after deletion of the overlapping nets with the reference voltage. For example, the 14th˜17th rows, the 24th˜27th rows, and the 30th˜35th rows in the post-conversion net list 28 shown in FIG. 10(c) correspond to the resistor elements inserted into the target net list. At this time, the resistor element name database 26 is searched, and a unique resistor element name is given to the resistor element to be inserted. Further, the names of the resistor elements inserted in the target net list as mentioned above are successively added to the resistor element name database 16 (the resistor element name database 26′ in FIG. 10(c)). By repeating this process, the net list of the target circuit is converted.

The circuit diagrams of the post-conversion net lists obtained by the above-mentioned net list conversion process are circuits 3721 and 3722 shown in FIG. 11. Since the details of these circuits are identical to those described for the second embodiment, repeated description is not necessary.

As described above, according to the third embodiment, the net list of the target circuit is converted so as to insert the resistors in the gate terminals of the MOS transistors in the target circuit. Therefore, whether the target circuit is an analog CMOS or a CMOS logic circuit, when the gate terminal of the MOS transistor is unfixed, the inserted resistor elements serve as a pull-up resistor and a pull-down resistor between the gate terminal of the MOS transistor and the power supply and between the gate terminal of the MOS transistor and the reference voltage. As the result, the gate terminal of the MOS transistor in which through current might flow under a stationary state can be fixed to a voltage between the power supply voltage and the reference voltage. This effect enables a stationary through current detection apparatus described later to reliably detect through current which cannot be easily detected by the conventional DC analysis simulation.

Furthermore, according to the third embodiment, the net extraction unit 12 detects MOS transistors from the target net list, and extracts nets connected to the gate terminals of the MOS transistors. Then, the overlapping net deletion unit 21 deletes overlapping nets from among the extracted nets, and thereafter, resistors are inserted into the nets. Therefore, it is possible to reliably detect transistors in the target circuit, which are suspected to cause through current, leasing to reliable detection of through current by a stationary through current detection apparatus described later, while it has been difficult for the conventional DC analysis simulation to detect such through current. Simultaneously, the number of resistor elements to be added to the net list can be minimized, whereby the analysis time required of the stationary through current detection apparatus described later can be reduced.

Furthermore, according to the third embodiment, the extracted net number counting unit 31 is provided, and the number of extracted nets after deletion of overlapping nets by the overlapping net deletion unit 21 is counted. Therefore, the number of nets to which resistor elements are to be inserted by the resistor insertion unit 13 can be obtained, whereby calculation of total through current can be realized in the through current detection apparatus described later.

### Embodiment 4

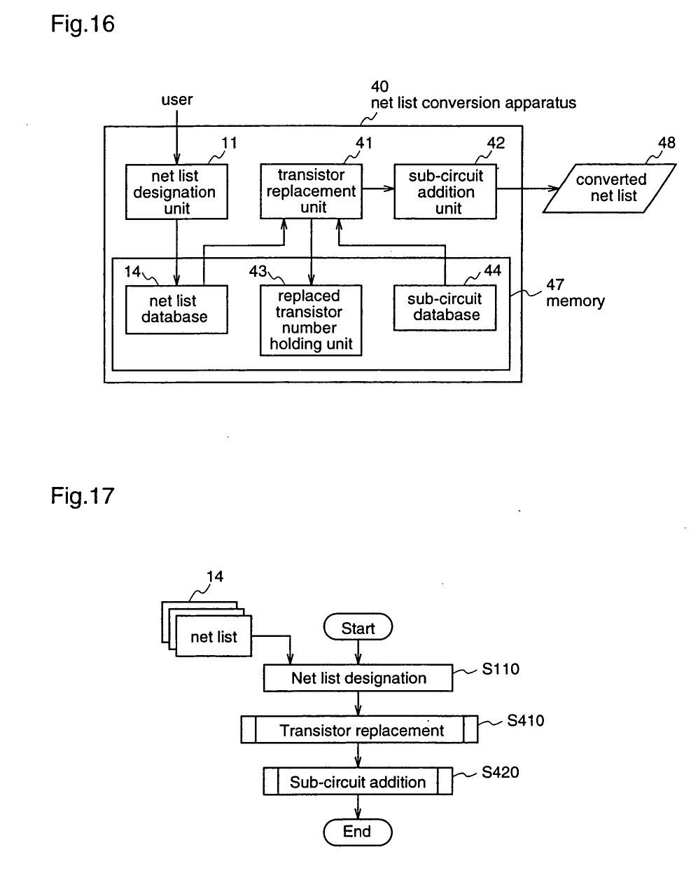

Hereinafter, a net list conversion apparatus 40 according to a fourth embodiment of the present invention will be described with reference to FIGS. 16˜21.

In the above-mentioned embodiments, the net extraction unit extracts, from the net list of the target circuit, the gate terminal of a MOS transistor which might cause a through current, and thereafter, the resistor insertion unit inserts a resistor connecting the extracted net with the power supply and a resistor connecting the extracted net with the reference voltage. In this fourth embodiment, however, the MOS transistor in which through current might occur, which is extracted from the net list of the target circuit, is initially replaced with a sub-circuit, and the contents of the sub-circuit in which a resistor is inserted in the gate terminal of the MOS transistor which might cause through current is added to the net list, as the contents of the sub-circuit with which the MOS transistor is replaced.

Initially, the construction of the net list conversion circuit 40 according to the fourth embodiment will be described with reference to FIG. 16. FIG. 16 is a block diagram illustrating the net list conversion apparatus according to the fourth embodiment.

With reference to FIG. 16, the net list conversion apparatus 40 comprises a net list designation unit 11, a transistor replacement unit 41, a sub-circuit addition unit 42, and a memory 47.

To be specific, the transistor replacement unit 41 replaces a MOS transistor to be subjected to conversion with a sub-circuit, in a through current detection target net list under a stationary state. The sub-circuit addition unit 42 adds the contents of the sub-circuit provided by the transistor replacement unit 41 into the target net list. The memory 47 comprises a net list database 14 for holding a net list of a target circuit, a replaced transistor number holding unit 43 for holding the number of transistors replaced by the transistor replacement unit 41, and a sub-circuit database 44 for previously holding sub-circuits to be added for the respective MOS transistors of different threshold values and kinds.

Next, the operation of the net list conversion apparatus 40 according to the fourth embodiment having the above-mentioned construction will be described with reference to FIGS. 17˜21. In this fourth embodiment, a description will be given of the case where the net lists of the circuits shown in FIGS. 37(a) and 37(b) (the target net list shown in FIG. 5(a)) are converted.

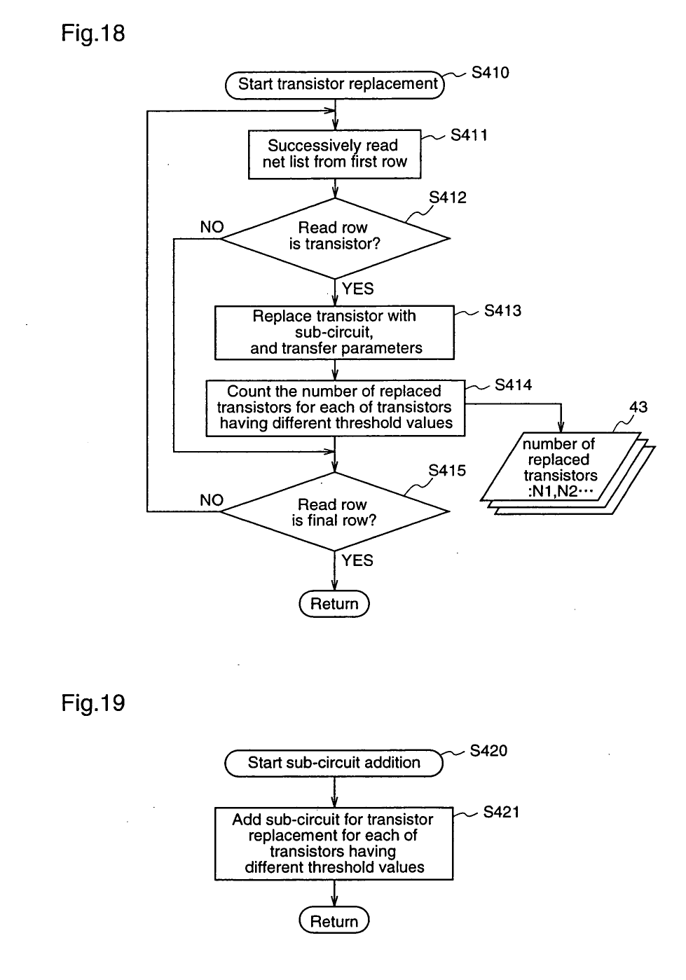

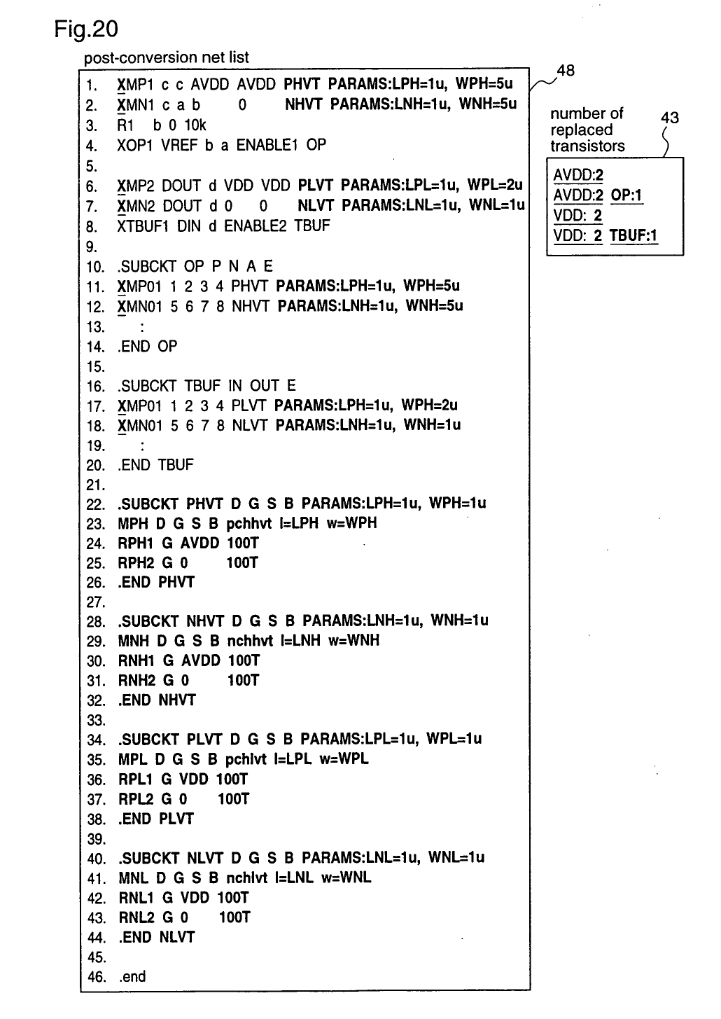

FIG. 17 is a diagram illustrating a series of steps of a net list conversion process by the net list conversion apparatus according to the fourth embodiment. FIG. 18 is a diagram illustrating specific steps of a transistor replacement process included in the net list conversion process shown in FIG. 17. FIG. 19 is a diagram illustrating a specific flow of a sub-circuit addition process included in the net list conversion process shown in FIG. 17. FIG. 20 is a diagram illustrating the contents of a post-conversion net list which is obtained by converting the net list shown in FIG. 5(a) by the net list conversion apparatus according to the fourth embodiment, and the contents of the replaced transistor number holding unit after the net list conversion process.

Initially, the user designates a target net list to be subjected to detection of through current in a stationary state by using the net list designation unit 11 (step S110 in FIG. 17). Next, the transistor replacement unit 41 replaces a MOS transistor as a conversion target with a sub-circuit (step S410 in FIG. 17). Then, it is checked whether the first character in the read row begins with “M” or not (step S412 in FIG. 18) to determine whether the read row is a description relating to a MOS transistor or not. When the first character in the read row begins with “M”, it is determined that the row is a description relating to a MOS transistor, and the next step S413 is executed; otherwise, step S415 is executed.

When it is determined in step S412 that the read row is a MOS transistor, the threshold value and type of the MOS transistor are determined from the sixth character string in the read row, i.e., from the model name of the MOS transistor. Thereafter, the description relating to the MOS transistor which is currently being read is replaced with a sub-circuit that is held in the replacement sub-circuit database 44 for each threshold and type of the MOS transistor (step S413 in FIG. 18). At this time, “X” is added at the head of the first character string in the row to be replaced. Further, the second, third, fourth, and fifth character strings of the MOS transistor, i.e., net information comprising “drain terminal”, “gate terminal”, “source terminal”, and “bulk terminal” and parameter information comprising “W:channel width”, “L:channel length”, “M:multiplier” and the like are extracted from the replaced MOS transistor, and the sub-circuit takes over these data. Of course, the sub-circuit can take over, besides the “W”, “L”, and “M”, “AD:drain diffused region”, “AS:source diffused region”, “PD:drain diffused region circumference length”, “PS:source diffused region circumference length” and the like.

Then, the number of replaced transistors is counted for each threshold value of the replaced MOS transistor, and the count value is stored in the replacement transistor number holding unit 43 (step S414 in FIG. 18). By repeating this, the net list of the target circuit is successively converted.

Thereafter, it is checked whether the read row is the final row or not (step S415 in FIG. 18). When it is the final row, the processing is ended; otherwise, the processing returns to step S411 to repeat the above-mentioned steps.

As described above, in step S415 in the transistor replacement process, when it is determined that the read row is the final row, the contents of the sub-circuit with which the MOS transistor is replaced in the transistor replacement process are added (step S420 in FIG. 17).

The sub-circuit addition process will be described in more detail. As shown in FIG. 19, a sub-circuit for transistor replacement is added to the target net list, for each of transistors having different threshold values (step S421 in FIG. 19).

A sub-circuit to be added in the sub-circuit addition process includes a MOS transistor corresponding to the threshold value and type of any of the MOS transistors, and a resistor element connecting the gate electrode of the MOS transistor with the power supply according to the threshold value of the MOS transistor, and connecting the gate terminal of the MOS transistor with the reference voltage.

Through the above-mentioned processing, a post-conversion net list 48 shown in FIG. 20 and the number of replaced transistors can be obtained from the target net list shown in FIG. 5(a).

Next, the operation of the net list conversion apparatus 40 according to the fourth embodiment will be described in more detail using the target net lists shown in FIGS. 5(a) and 20.

Initially, the target net list shown in FIG. 5(a) is designated using the net list designation unit 11.

Next, in the transistor replacement unit 41, a MOS transistor as a conversion target is replaced with a sub-circuit. At this time, the transistor replacement unit 41 reads the target net list shown in FIG. 5(a), row-by-row, starting from the first row. Then, it is checked whether the first character in the read row begins with “M” or not (underlined portions in FIG. 5(a)) to determine whether the read row is a description relating to a MOS transistor or not. In FIG. 5(a), it is determined that the 1st, 2nd, 6th, 7th, 11th, 12th, 17th, and 18th rows are descriptions relating to MOS transistors.

Then, the threshold value and type of the MOS transistor is determined from the sixth character string in the read row (underlined bold character portions in the 1st, 2nd, 6th, 7th, 11th, 12th, 17th and 18th rows in FIG. 5(a)), i.e., from the model name of the MOS transistor. In FIG. 5(a), it is determined that the MOS transistor has a high threshold value (HVT) when the sixth character string is pchhvt or nchhvt, while it has a low threshold value (LVT) when the sixth character string is pchlvt or nchlvt.

Then, the description relating to the MOS transistor that is currently being read is replaced with a sub-circuit that is provided for each threshold value and type of the MOS transistor. At this time, “X” is added to the head of the first character string in this row, and the second, third, fourth, and fifth character strings of the MOS transistor to be replaced, i.e., the net information comprising “drain terminal”, “gate terminal”, “source terminal”, and “bulk terminal” of this MOS transistor are transferred as they are into the sub-circuit. Further, the parameter information comprising “W:channel width”, “L:channel length”, “M:multiplier” and the like are also transferred into the sub-circuit using “PARAMS”. In the post-conversion net list 48 shown in FIG. 20, the 1st˜2nd, 6th˜7th, 11th˜12th, and 17th˜18th rows correspond to the rows which are transferred from the MOS transistor to the sub-circuit.

Simultaneously, the MOS transistors replaced with the sub-circuits by the transistor replacement unit 41 are counted for each of the transistors having different threshold values. The contents of the replaced transistor number holding unit 43 corresponds thereto.

Then, the sub-circuit addition unit 42 adds the contents of the sub-circuit to be replaced from the MOS transistor to the sub-circuit. In the post-conversion net list 48 shown in FIG. 20, a description of a sub-circuit relating to a Pch HVTMOS transistor corresponds to the 22nd˜26th rows, a description of a sub-circuit relating to a Nch HVTMOS transistor corresponds to the 28th˜32nd rows, a description of a sub-circuit relating to a Pch LVTMOS transistor corresponds to the 34th˜38th rows, and a description of a sub-circuit relating to a Nch LVTMOS transistor corresponds to the 40th˜44th rows.

The added sub-circuit includes one MOS transistor corresponding to any of the MOS transistors of different threshold values and types, and a resistor element connecting the gate electrode of the MOS transistor with the power supply according to the threshold value of the MOS transistor, and a resistor element connecting the gate terminal of the MOS transistor with the reference voltage. The net list of the target circuit is continuously converted by repeating the above-mentioned processing.

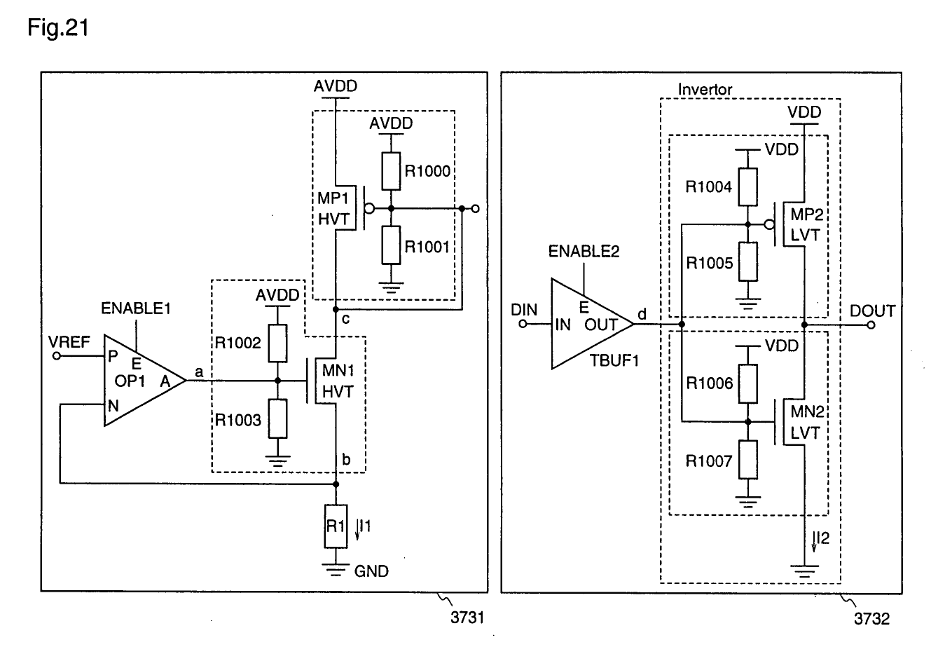

The circuit diagrams of the post-conversion net lists obtained by the above-mentioned net list conversion process are circuits 3731 and 3732 shown in FIG. 21. As is evident from FIG. 21, in the net list conversion process by the net list conversion apparatus 40 according to the fourth embodiment, as many resistors as those inserted by the net list conversion apparatus 10 according to the first embodiment are inserted. However, the circuit construction of the net list 48 converted by the net list conversion apparatus 40 according to the fourth embodiment (refer to FIG. 20) is simpler than that of the net list 18 converted by the net list conversion apparatus 10 according to the first embodiment (refer to FIG. 5(c)). Further, since the resistor elements are added while maintaining the state of the net list before conversion, the net list after conversion is easy to see, and the circuit construction can be easily known from the net list after conversion.

As described above, according to the fourth embodiment, a MOS transistor in a circuit as a conversion target is replaced with a sub-circuit including resistors. Therefore, whether the target circuit is an analog CMOS or a CMOS logic circuit, when the gate terminal of the MOS transistor is unfixed, the resistor elements inserted in the sub-circuit that is provided in place of the MOS transistor serve as a pull-up resistor and a pull-down resistor between the gate terminal of the MOS transistor and the power supply and between the gate terminal of the MOS transistor and the reference voltage. As the result, the gate terminal of the MOS transistor in which through current might flow in a stationary state can be fixed to a voltage between the power supply voltage and the reference voltage.

Furthermore, according to the fourth embodiment, the MOS transistor is replaced with a sub-circuit including resistors, instead of inserting resistors directly to the gate terminal of the MOS transistor. Therefore, the net list after conversion is easy to see, and the circuit construction is easily known from the net list after conversion.

### Embodiment 5

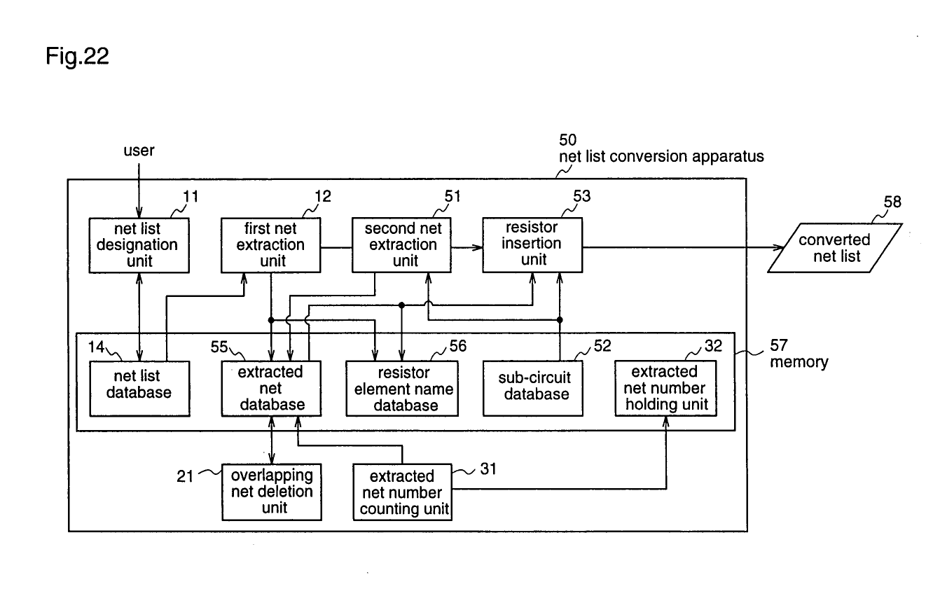

Hereinafter, a net list conversion apparatus 50 according to a fifth embodiment of the present invention will be described with reference to FIGS. 22˜26.

In the above-mentioned embodiments, all the MOS transistors are extracted from the net list of the target circuit, and resistors are inserted to the MOS transistor. In this fifth embodiment, however, with respect to a target circuit having a high reliability, even when MOS transistors are included in the target circuit, no resistors are inserted to MOS transistors.

Initially, the construction of the net list conversion apparatus according to the fifth embodiment will be described with reference to FIG. 22. FIG. 22 is a block diagram illustrating the net list conversion apparatus 50 according to the fifth embodiment.

With reference to FIG. 22, the net list conversion apparatus 50 comprises a net list designation unit 11, a first net extraction unit 12, a second net extraction unit 51, an overlapping net deletion unit 21, a resistor insertion unit 53, and a memory 57 including a net list database 14, an extracted net database 55, a resistor element name database 56, and a sub-circuit database 52.

To be specific, the first net extraction unit 12 extracts nets connected to MOS transistors in a through current detection target net list under a stationary state, and this unit corresponds to the net extraction unit of the respective embodiments mentioned above. The second net extraction unit 51 extracts a net connected to an input terminal of a specific sub-circuit from the stationary through current detection target net list. Further, the resistor insertion unit 53 inserts a resistor element connecting a specific net with a power supply and a resistor element connecting the specific net with a reference voltage, which specific net is other than a net connected to a gate terminal of a MOS transistor included in a specific sub-circuit, among the nets which are extracted by the first net extraction unit 12 and the second net extraction unit 51, from which overlapping nets are deleted by the overlapping net deletion unit 21. The sub-circuit database 52 in the memory 57 indicates information of the sub-circuit extracted by the second net extraction unit 51. Since other constituents are identical to those described for the second embodiment, repeated description is not necessary.

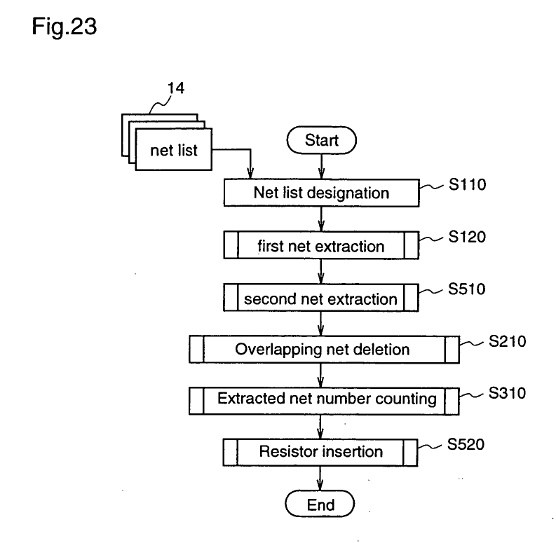

Next, the operation of the net list conversion apparatus 50 according to the fifth embodiment having the above-mentioned construction will be described with reference to FIGS. 23˜26. In this fifth embodiment, a description will be given of the case where the net lists of the circuits shown in FIGS. 37(a) and 37(b) are to be converted to detect stationary through currents in these circuits.

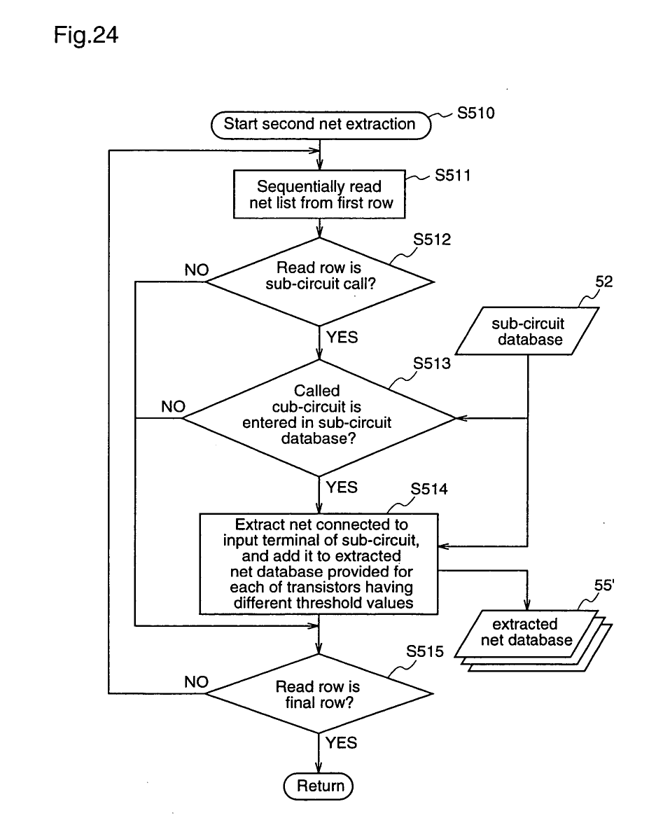

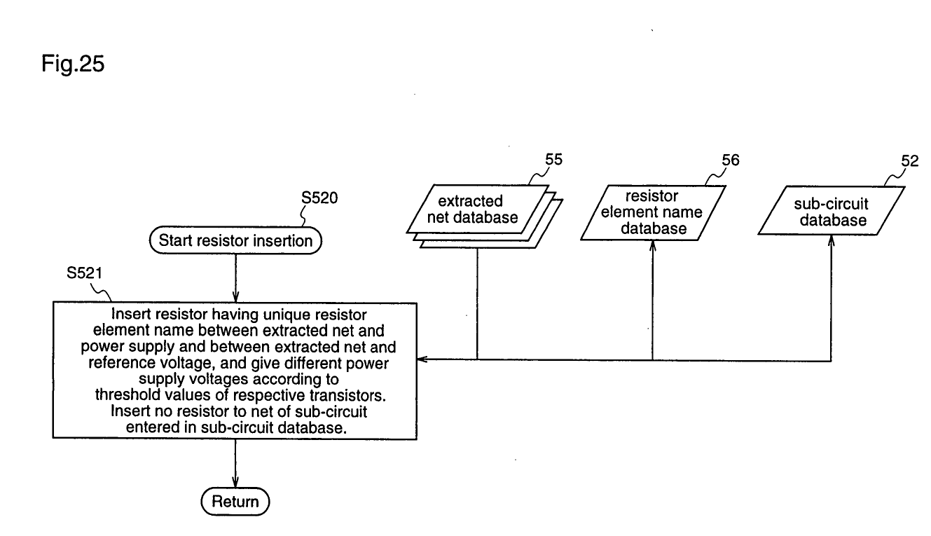

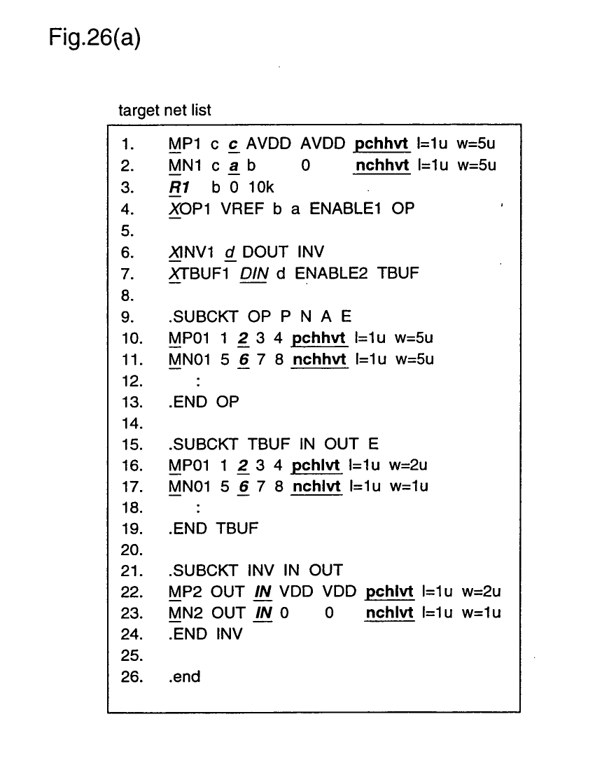

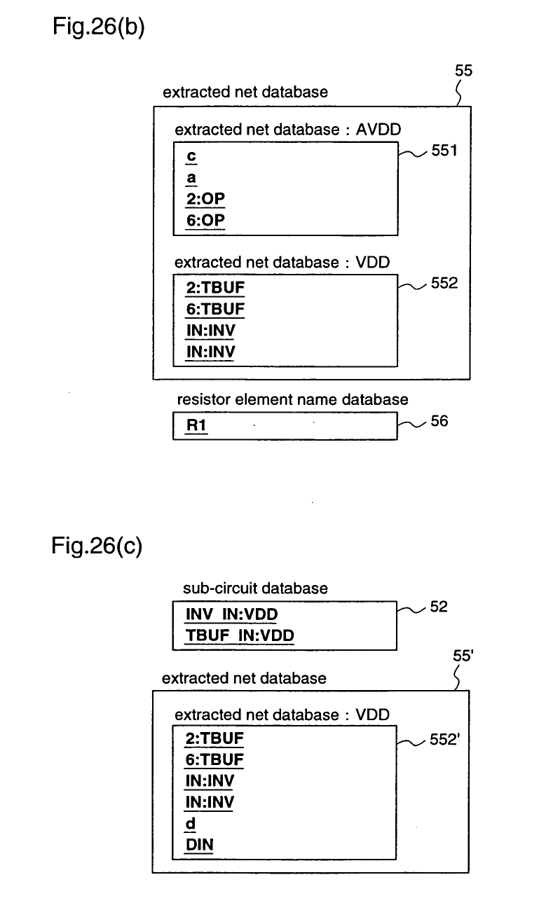

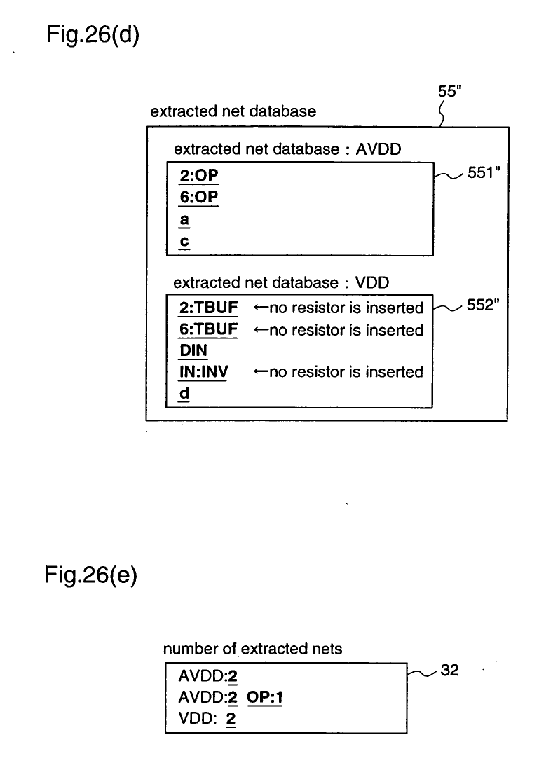

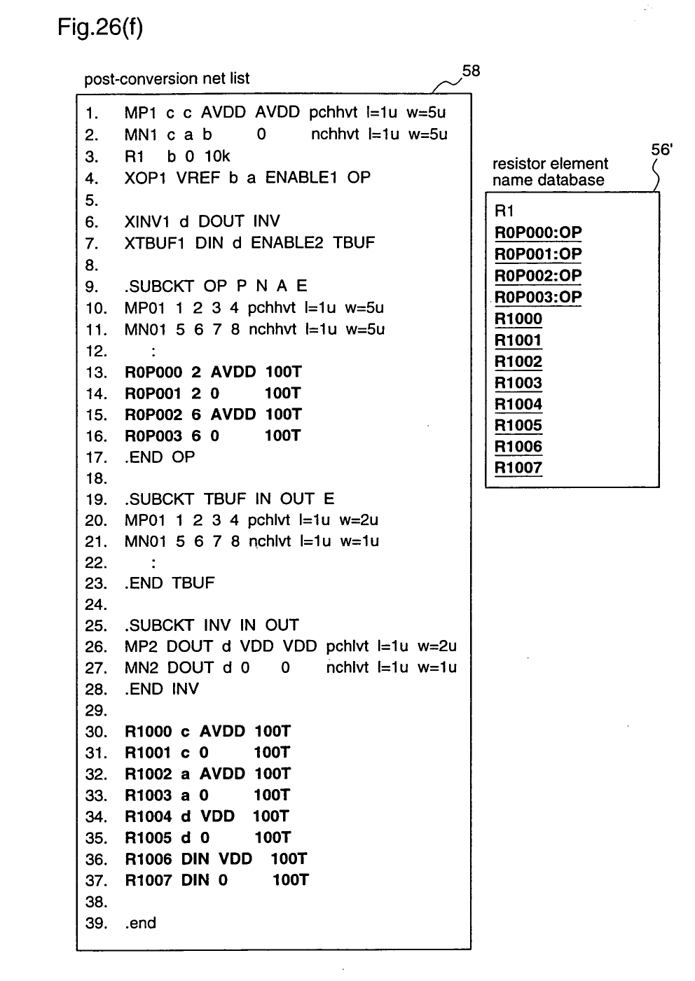

FIG. 23 is a diagram illustrating a series of steps in a net list conversion process by the net list conversion apparatus according to the fifth embodiment. FIG. 24 is a diagram illustrating specific steps of a second net extraction process included in the net list conversion process shown in FIG. 23. FIG. 25 is a diagram illustrating a specific flow of a resistor insertion process included in the net list conversion process shown in FIG. 23. FIG. 26(a) is a diagram showing a net list of a target circuit (the circuits shown in FIGS. 37(a) and 37(b)) which is subjected to net list conversion by the net list conversion apparatus according to the fifth embodiment. FIG. 26(b) is a diagram illustrating the extracted net database and the resistor element name database which are extracted by the net extraction unit of the net list conversion apparatus according to the fifth embodiment. FIG. 26(c) is a diagram showing the contents of the sub-circuit database and the contents of the extracted net database that has been processed by the second net extraction unit. FIG. 26(d) is a diagram showing the contents of the extracted net database that has been processed by the overlapping net deletion unit. FIG. 26(e) is a diagram showing the number of extracted nets that is counted by extracted net number counting unit. FIG. 26(f) is a diagram illustrating the post-conversion net list which is obtained by net list converting the net list shown in FIG. 26(a) by the net list conversion apparatus according to the fifth embodiment, and the resistor element name database after the conversion.

Initially, the user designates a target net list to be subjected to detection of stationary through current, by using the net list designation unit 11 (step S110 in FIG. 23).

Since this process is identical to that described for the first embodiment, repeated description is not necessary.

Next, the first net extraction unit 12 performs a first net extraction process for extracting nets connected to the gate terminals of the MOS transistors included in the target net list shown in FIG. 26(a) (step S120 in FIG. 23). Since this process is identical to the net extraction process which has been described with respect to FIG. 3 for the first embodiment, repeated description is not necessary.

Thereafter, the second net extraction unit 51 again reads the target net list shown in FIG. 26(a) which is designated by the net list designation unit 11, and extracts a net connected to an input terminal of a specific sub-circuit as a conversion target, from the target net list.

Hereinafter, the second net extraction process will be described in detail with reference to FIG. 24.

Initially, the target net list designated by the net list designation unit 11 is sequentially read, row-by-row, starting from the first row (step S511 in FIG. 24). Next, it is checked whether the read row is a description relating to a sub-circuit or not (step S512 in FIG. 24). In this fifth embodiment, it is checked whether the first character in the read row begins with “X” or not. That is, when the first character in the read row begins with “X”, it is determined that this row is a description relating to a sub-circuit, and next step S513 is executed; otherwise, step S515 is executed.

When it is determined that the read row corresponds to a sub-circuit in step S512, it is checked whether the final character string in the read row, i.e., the name of the read sub-circuit, is included in the sub-circuit database 52 or not (step S513 in FIG. 24). When it is determined that the name of the read sub-circuit is included in the sub-circuit database 52, the next step S514 is executed; otherwise, step S515 is executed.

Then, in step S514, on the basis of the input terminal information of the sub-circuits included in the sub-circuit database 52 and the threshold value information of the MOS transistors corresponding to the input terminals, a net connected to the input terminal of the sub-circuit is extracted, and the extracted net is added to the extracted net database 55 that is provided for each of the MOS transistors having different threshold values which are obtained by the first net extraction unit 12, thereby obtaining a new extracted net database 55′. The newly obtained extracted net database 55′ is shown in FIG. 26(c).

Thereafter, it is checked whether the read row is the final row or not (step S515 in FIG. 24). When it is the final row, the processing is ended; otherwise, the processing returns to step S511 to repeat the above-mentioned steps.

After the first and second net extraction processes are completed, the overlapping net deletion unit 21 deletes overlapping nets from the extracted net database 55′ obtained by the second net extraction process, thereby obtaining an extracted net database 55″ from which overlapping nets are deleted. Then, the extracted net number counting unit 31 counts the number of nets included in the extracted net database 55″ after the deletion of overlapping nets, and the count value is stored in the extracted net number holding unit 32 in the memory 57 (refer to FIG. 26(e)) for each threshold value of the MOS transistors (step S310 in FIG. 23). Since these steps are identical to those described for the third embodiment using FIG. 14, repeated description is not necessary.

After the overlapping nets are deleted by the overlapping net deletion unit 21 and the new extracted net database 55″ is outputted, the resistor insertion process is carried out, that is, the resistor insertion unit 53 inserts, in the target net list, a resistor element connecting a specific net with the power supply and a resistor element connecting the specific net with the reference voltage, which specific net is other than the net connected to the gate terminal of the MOS transistor included in the sub-circuit database 52, among the nets from which the overlapping nets are deleted as shown in FIG. 26(d) (step S520 in FIG. 23).

Hereinafter, the resistor insertion process will be described in detail with reference to FIG. 25. The resistor insertion unit 53 inserts, in the net list, a resistor element connecting a specific net with the power supply and a resistor element connecting the specific net with the reference voltage, which specific net is other than the net connected to the gate terminal of the MOS transistor included in the specific sub-circuit stored in the sub-circuit database 52, among the nets extracted by the first and second net extraction units 12 and 51, from which overlapping nets are deleted by the overlapping net deletion unit 21. In this fifth embodiment, among the nets included in an extracted net database:ADVV 551″ and an extracted net database:VDD 552″ which are extracted for the respective threshold values of the MOS transistors in the extracted net database 55″, a resistor is inserted between a specific net and the power supply determined for each threshold value of the MOS transistor, which net is other than the net connected to the gate terminal of the MOS transistor included in the sub-circuit database 52, and between the specific net and the reference voltage (step S521 in FIG. 25). At this time, unique resistor element names are given to the respective inserted resistor elements by searching through the resistor element name database 56. Further, the names of the inserted resistor elements are added to the resistor element name database 56′. By repeating this process, the net list of the target circuit is converted.

Through the above-mentioned processing, a post-conversion net list 58 and a resistor element name database 56′ to which the resistor added to the net list is added, which are shown in FIG. 26(f), and the number of extracted nets 32 shown in FIG. 26(e) are obtained from the target net list shown in FIG. 26(a).

Next, the operation of the net list conversion apparatus 50 according to the fifth embodiment will be described in more detail with reference to the net list shown in FIG. 26.

Initially, the user designates the target net list shown in FIG. 26(a) by using the net list designation unit 11. FIG. 26(a) shows a SPICE format net list expressing the circuit diagrams shown in FIGS. 37(a) and 37(b), like FIG. 5(a). FIG. 26(a) is different from FIG. 5(a) in that an inverter formed of MP2 and MN2 in the 6th˜7th rows in FIG. 5(a) is expressed as a sub-circuit INV in the 6th row in FIG. 26(a), and a description relating to the contents of the sub-circuit INV is added in the 21st˜24th rows.

Next, the first net extraction unit 12 extracts a net to be subjected to conversion, from the target net list. At this time, the first net extraction unit 12 checks whether the first character in the read row begins with “M” or not (underlined portion in FIG. 26(a)) to determine whether the read row is a description relating to a MOS transistor or not. In FIG. 26(a), it is determined that the 1st, 2nd, 10th, 11th, 16th, 17th, 22nd, and 23rd rows are descriptions relating to MOS transistors.

Then, a threshold value of the MOS transistor is determined from the sixth character string in the read row (underlined bold character portions in the 1st, 2nd, 10th, 11th, 16th, 17th, 22nd, and 23rd rows in FIG. 26(a)), i.e., from the model name of the MOS transistor. In FIG. 26(a), it is determined that the MOS transistor is a HVTMOS transistor when the sixth character string is pchhvt or nchhvt, and that the MOS transistor is a LVTMOS transitor when the sixth character string is pchlvt or nchlvt.

Simultaneously, the third character string in the read row (underlined bold diagonal letter portions in the 1st, 2nd, 10th, 11th, 16th, 17th, 22nd and 23rd rows in FIG. 5(a)), i.e., a net connected to the gate electrode of the MOS transistor, is added to the extracted net database 55 which is provided for each threshold value of the MOS transistor. The extracted net database:AVDD 551 shown in FIG. 26(b) corresponds to the extracted net database of the HVTMOS transistor in the target net list shown in FIG. 26(a), and the extracted net database:VDD 552 shown in FIG. 26(b) corresponds to the extracted net database of the LVTMOS transistor.

Next, it is determined whether the read row is a description relating to a resistor element or not by checking whether the first character in the read row begins with “R” or not (underlined bold diagonal letter portion in the third row in FIG. 26(a)). In the target net list shown in FIG. 26(a), it is determined that the 3rd row is a description relating to a resistor element. Then, the first character string in the read row (underlined bold diagonal letter portion in the third row in FIG. 26(a)), i.e., the resistor element name of the resistor element is added to the resistor element name database 56. In FIG. 26(a), the resistor element name database 56 shown in FIG. 26(b) corresponds thereto.

When the target net list shown in FIG. 26(a) is read up to the last row, the second net extraction unit 51 extracts a net connected to the input terminal of a specific sub-circuit to be subjected to conversion, from the target net list designated by the net list designation unit 11.

In this fifth embodiment, the target net list designated by the net list designation unit 11 is sequentially read, row-by-row, starting from the first row, and it is checked whether the first character in the read row begins with “X” or not (underlined diagonal letter portions in FIG. 26(a)), whereby it is determined whether the read row is a description relating to a sub-circuit or not. In FIG. 26(a), it is determined that the 4th, 6th, and 7th rows are descriptions relating to sub-circuits.

Thereafter, it is checked whether the last character string in the read row, i.e., the name of the read sub-circuit, is included in the sub-circuit database 52 or not. The sub-circuit database 52 corresponds to FIG. 26(c), and includes the input terminal information of the sub-circuit, and the threshold value information of the MOS transistor of the input terminal. In FIG. 26(a), the 6th and 7th rows correspond to sub-circuits included in the sub-circuit database 52.

Then, on the basis of the input terminal information of the sub-circuit included in the sub-circuit database 52 as well as the threshold value information of the MOS transistor of the input terminal, the second net extraction unit 51 extracts a net connected to the input terminal of the sub-circuit, and adds the extracted net to the extracted net database 55 (refer to FIG. 26(b)) that is provided for each of the MOS transistors having different threshold values, thereby obtaining a new extracted net database 55′. In this fifth embodiment, the second net extraction unit 51 adds the net to the extracted net database relating to the LVTMOS transistor, and the extracted net database:VDD 552′ shown in FIG. 26(c) corresponds thereto.

Next, the overlapping net deletion unit 21 sequentially reads the nets stored in the extracted net database:AVDD 551 shown in FIG. 26(a) and the extracted net database:VDD 552′ shown in FIG. 26(c), and rearranges the rows read from the respective extracted net databases in lexicographical order, and thereafter, deletes overlapping nets. In FIG. 26(c), since the net IN:INV overlaps, the overlapping of nets in the extracted net database:VDD 552′ is resolved. After deletion of the overlapping net, a new extracted net database 55″ is obtained. The extracted net database:AVDD 551″ and the extracted net database:VDD 552″ shown in FIG. 26(d) are obtained from FIGS. 26(b) and 26(c), respectively.

Thereafter, the extracted net number counter unit 31 counts the number of nets included in the extracted net database 55″. At this time, the nets included in the sub-circuit database 52 are not counted (not shown). The number of nets included in the extracted net database:AVDD 551″ shown in FIG. 26(d), i.e., the number of nets relating to the HVTMOS transistor is “2” in the top-level hierarchy, and “2” in the operation amplifier OP hierarchy. On the other hand, the number of nets included in the extracted net database:VDD 552″ shown in FIG. 26(d), i.e., the number of nets relating to the LVTMOS transistor is “2” in the top-level hierarchy. The information relating to the numbers of nets is stored in the extracted net number holding unit 32. In this fifth embodiment, FIG. 26(e) corresponds thereto.

Next, the resistor insertion unit 52 inserts, in the target net list, a resistor connecting a net other than the net connected to the gate terminal of the MOS transistor included in the specific sub-circuit with the power supply, and a resistor connecting the specific net with the reference voltage, among the nets extracted by the first and second net extraction units 12 and 51, from which overlapping nets are deleted by the overlapping net deletion unit 21. In this fifth embodiment, the resistor insertion unit 52 inserts, in the target net list, a resistor element connecting a specific net other than the net connected to the gate terminal of the MOS transistor included in the sub-circuit database 52 with the power supply that is determined for each threshold value of the MOS transistor, and a resistor element connecting the specific net with the reference voltage, among the nets included in the extracted net database 55″ (corresponding to FIG. 26(d)) extracted for each threshold value of the MOS transistor. As shown in FIG. 26(d), since “TBUF” and “INV” are included in the sub-circuit database 52, they are excluded from the specific net. The 13th˜16th rows and the 30th˜37th rows in FIG. 26(f) correspond to the resistor elements inserted in the net list.

At this time, unique resistor element names are given to the respective inserted resistor elements by searching through the resistor element name database 56. Further, the names of the resistor elements inserted in the target net list as described above are successively added to the resistor element name database 56 (resistor element name database 56′ shown in FIG. 26(f)). By repeating this processing, the target net list is converted.

As described above, according to the fifth embodiment, the net list of the target circuit is converted so as to insert resistors into the gate terminals of the MOS transistors in the target circuit. Therefore, whether the target circuit is an analog CMOS or a CMOS logic circuit, when the gate terminal of the MOS transistor is unfixed, the inserted resistor element serves as a pull-up resistor and a pull-down resistor between the gate terminal of the MOS transistor and the power supply and between the gate terminal of the MOS transistor and the reference voltage. As the result, the gate terminal of the MOS transistor in which through current might flow under a stationary state can be fixed to a voltage between the power supply voltage and the reference voltage. This effect enables a stationary through current detection apparatus described later to reliably detect through current which cannot be easily detected by the conventional DC analysis simulation.

Furthermore, according to the fifth embodiment, in addition to deletion of overlapping nets in the extracted net database by the overlapping net deletion unit 21, a circuit which is not suspected to occur through current is previously stored in the sub-circuit database 52. When insertion of resistors is carried out by the resistor insertion unit 53, no resistor is inserted in the position indicated in the sub-circuit database 52. Therefore, it is possible to reliably detect a transistor which might occur through current in the target circuit, and this effects enables a stationary through current detection apparatus described later to reliably detect through current which is not easily detected by the conventional DC analysis simulation. Further, with respect to the nets included in the sub-circuit database 52, since only the net connected to the input terminal of the sub-circuit is subjected to resistor insertion, the number of resistor elements to be inserted in the net list can be significantly reduced, whereby the analysis time in the stationary through current detection apparatus described later can be further reduced.

Furthermore, the fifth embodiment is provided with the extracted net number counter unit 31, and the number of extracted nets after deletion of overlapping nets by the overlapping net deletion unit 21 is counted. Therefore, the number of nets to which resistor elements are inserted by the resistor insertion unit 13 can be obtained, whereby calculation of total through current can be realized in the through current detection apparatus described later.

In this fifth embodiment, after the net extraction unit extracts the gate terminals of MOS transistors which might occur through current from the net list of the target circuit, the resistor insertion unit inserts a resistor so as to connect each of the extracted net with the power supply, and connect the extracted net with the reference voltage, as described in the first to third embodiments. However, as described in the fourth embodiment, after a MOS transistor that might occur through current in the target circuit net list is initially replaced with a sub-circuit, the contents of the sub-circuit in which a resistor is inserted in the gate terminal of the MOS transistor that might occur through current may be added to the net list as the contents of the sub-circuit.

### Embodiment 6

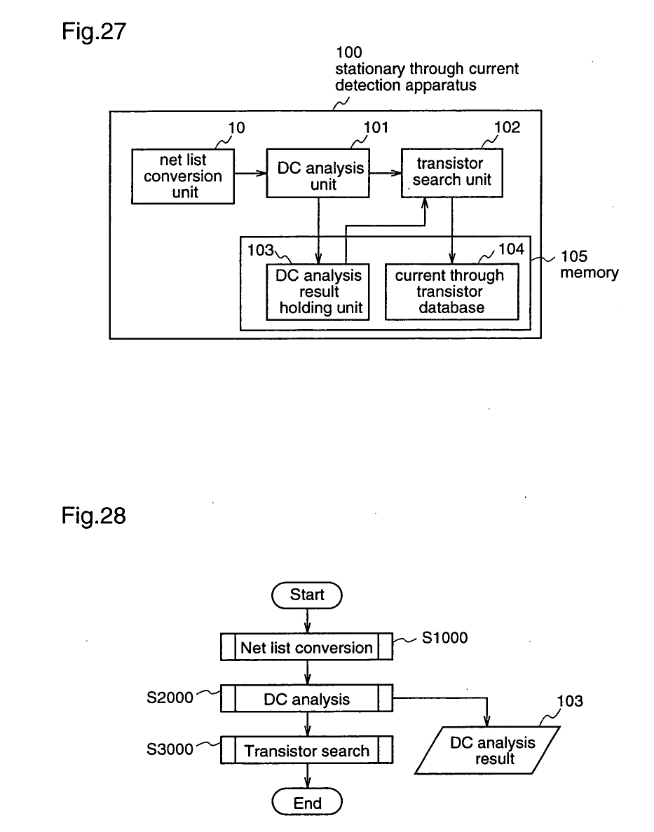

Hereinafter, a stationary through current detection apparatus 100 according to a sixth embodiment will be described with reference to FIGS. 27˜29.

In this sixth embodiment, after a stationary through current detection target net list is subjected to conversion by the net list conversion apparatus described for any of the first to fifth embodiments, through current in a stationary state of the net list is detected.

Initially, the construction of the stationary through current detection apparatus 100 according to the sixth embodiment will be described with reference to FIG. 27. FIG. 27 is a block diagram illustrating the construction of the stationary through current detection apparatus 100 according to the sixth embodiment.

With reference to FIG. 27, the stationary through current detection apparatus 100 comprises a net list conversion unit 10, a DC analysis unit 101, a transistor search unit 102, and a memory 105.

More specifically, the net list conversion unit 10 converts a net list of a stationary through current detection target circuit so as to insert a resistor in a position where through current might occur. The construction thereof is identical to any of the first to fifth embodiments described above. The DC analysis unit 101 performs DC analysis on the post-conversion net list that has been subjected to net list conversion, thereby obtain a DC analysis result. The transistor search unit 102 searches for a MOS transistor in which through current occurs, on the basis of the DC analysis result obtained by the DC analysis unit 101. The memory 105 includes a DC analysis result holding unit 103 for holding the DC analysis result, and a current through transistor database 104 for holding the position where through current might occur, which position is searched by the transistor search unit 102.

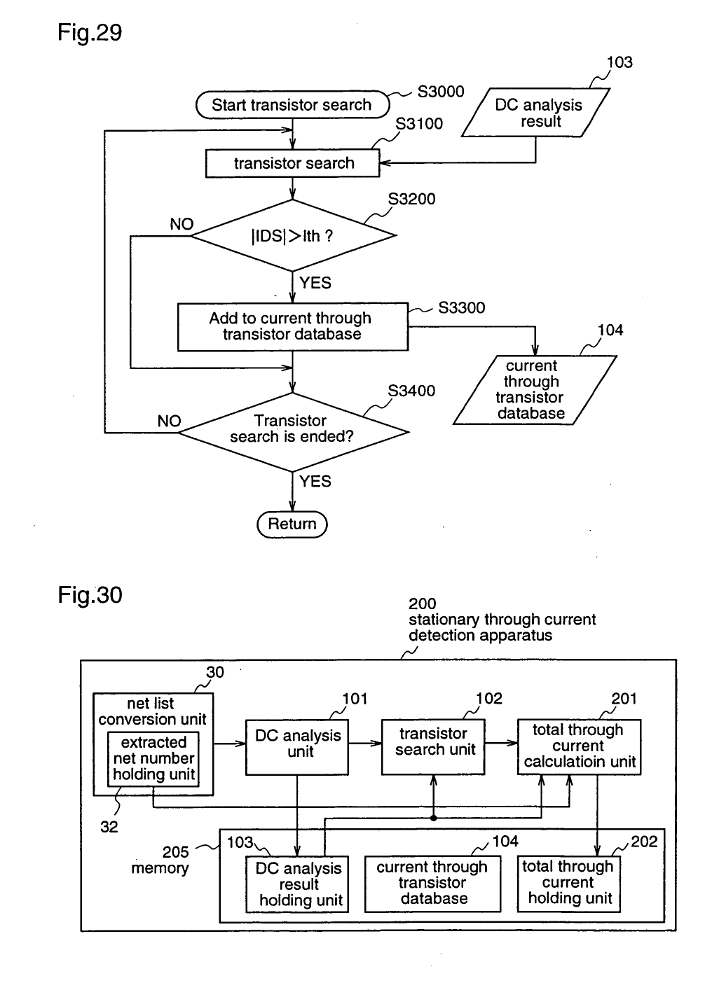

Hereinafter, the operation of the stationary through current detection apparatus 100 according to the sixth embodiment having the above-mentioned construction will be described with reference to FIGS. 28 and 29. It is assumed that stationary through currents in the circuits shown in FIGS. 37(a) and 37(b) are detected.

FIG. 28 is a diagram illustrating a series of steps of a through current detection process by the stationary through current detection apparatus according to the sixth embodiment, and FIG. 29 is a diagram illustrating specific steps of a transistor search process included in the through current detection process shown in FIG. 28.

Initially, when the user designates a circuit to be subjected to stationary through current detection by using the net list designation unit (not shown) in the net list conversion unit 10, the net list conversion unit 10 executes net list conversion on the net list of the designated target circuit (step S1000 in FIG. 28). This operation is identical to those described for the first to fifth embodiments.

Then, the DC analysis unit 101 executes DC analysis on the net list converted by the net list conversion unit 10 to obtain a DC analysis result, and stores this into the DC analysis result holding unit 103 in the memory 105 (step S2000 in FIG. 28). Since the operation of DC analysis is identical to the conventional DC analysis, repeated description is not necessary.

Thereafter, the transistor search unit 102 searches for a MOS transistor which might cause through current, on the basis of the DC analysis result obtained by the DC analysis unit 101. The result is stored in the current through transistor database 104 in the memory 105 (step S3000 in FIG. 28).

Hereinafter, the transistor search process will be described in detail with reference to FIG. 29.

Initially, the DC analysis result obtained by the DC analysis unit 101 is searched for information relating to MOS transistors (step S3100 in FIG. 29). When |IDS|>Ith, step S3300 is executed; otherwise, step S3400 is executed. That is, when the |IDS| is larger than Ith, it is determined that through current occurs in the corresponding MOS transistor, and the MOS transistor is added to the current through transistor database 104 (step S3300 in FIG. 29). When the |IDS| is smaller than Ith, it is determined that no through current occurs in the MOS transistor. Thereafter, it is checked whether the searched MOS transistor is the last MOS transistor or not (step S3400 in FIG. 29). When it is the last MOS transistor, the processing is ended; otherwise, the processing returns to step S3100 to repeat the above-mentioned-steps.

In this way, a position where through current might occur in a stationary state is detected, and the current through transistor database 104 is outputted.

Next, the operation of the stationary through current detection apparatus 100 according to the sixth embodiment will be described in more detail using the net list shown in FIG. 26. It is assumed that the net list conversion unit is the net list conversion apparatus according to the fifth embodiment.

Initially, it is assumed that the target net list shown in FIG. 26(a) is subjected to net list conversion by the net list conversion unit 10 which is identical to the net list conversion apparatus of the fifth embodiment, and thereby the post-conversion net list shown in FIG. 26(f) is obtained.

Now it is assumed that, when detecting stationary through, a control signal ENABLE1 of OP1 and a control signal ENABLE2 of TBUF 1 are “L”. At this time, the net “a” in the circuit 3701 shown in FIG. 37(a) becomes unfixed, leading to a possibility of through current I1. Likewise, the net “d” in the circuit 3702 shown in FIG. 37(b) also becomes unfixed, leading to a possibility of through current I2. However, when the post-conversion net list 58 shown in FIG. 26(f) is subjected to DC analysis, the net “a” is fixed at a voltage at a middle point between the power supply voltage AVDD and the reference voltage due to the function of the R1002 and R1003, and the net “d” is fixed to a voltage at a middle point between the power supply voltage VDD and the reference voltage due to the function of the R1004 and R1005, whereby through currents 11 and 12 flow, which cannot be easily detected by the conventional DC analysis simulation. Other nets operate at ordinary DC operating points.

As described above, according to the sixth embodiment, the net list of the stationary through detection target circuit is subjected to net list conversion so as to insert a resistor in a position where through current might occur, and thereafter, current of the MOS transistor is monitored. Therefore, it is possible to easily detect a position where leakage current might occur, which position is difficult to be detected by the ordinary DC analysis.

While in this sixth embodiment the net list conversion apparatus 50 described for the fifth embodiment corresponds to the net list conversion unit 10, the net list conversion unit 10 may be any of the net list conversion apparatuses 10 to 40 according to the first to fourth embodiments with the same effects as mentioned above.

### Embodiment 7

Hereinafter, a stationary through detection apparatus 200 according to a seventh embodiment will be described with reference to FIGS. 30˜32.

While in the sixth embodiment positions where stationary through might occur are detected, in this seventh embodiment, furthermore, total through current in a stationary state of a net list is calculated.

Initially, the construction of the stationary through detection apparatus 200 according to the seventh embodiment will be described with reference to FIG. 30. FIG. 30 is a block diagram illustrating the construction of the stationary through detection apparatus 200 according to the seventh embodiment.

With reference to FIG. 30, the stationary through detection apparatus 200 comprises a net list conversion unit 30, a DC analysis unit 101, a transistor search unit 102, a total through current calculation unit 201, and a memory 205 including a DC analysis result holding unit 103, a current through transistor database 104, and a total through current holding unit 202.

More specifically, the net list conversion unit 30 converts a net list of a stationary through detection target circuit so as to insert a resistor in a position where through current might occur. Since, in this seventh embodiment, total through current is calculated, the construction of the net list corresponds to that of the net list conversion apparatus according to any of the third to fifth embodiments, which counts the number of resistors inserted during the net list conversion process.

The total through current calculation unit 201 subtracts a current that flows through a resistor element inserted between the power supply and the reference voltage, from the current flowing in the power supply, thereby calculating total through current. The total through current holding unit 202 in the memory 205 holds a value obtained by the total through current calculation unit 201. Since other constituents are identical to those described for the sixth embodiment, repeated description is not necessary.

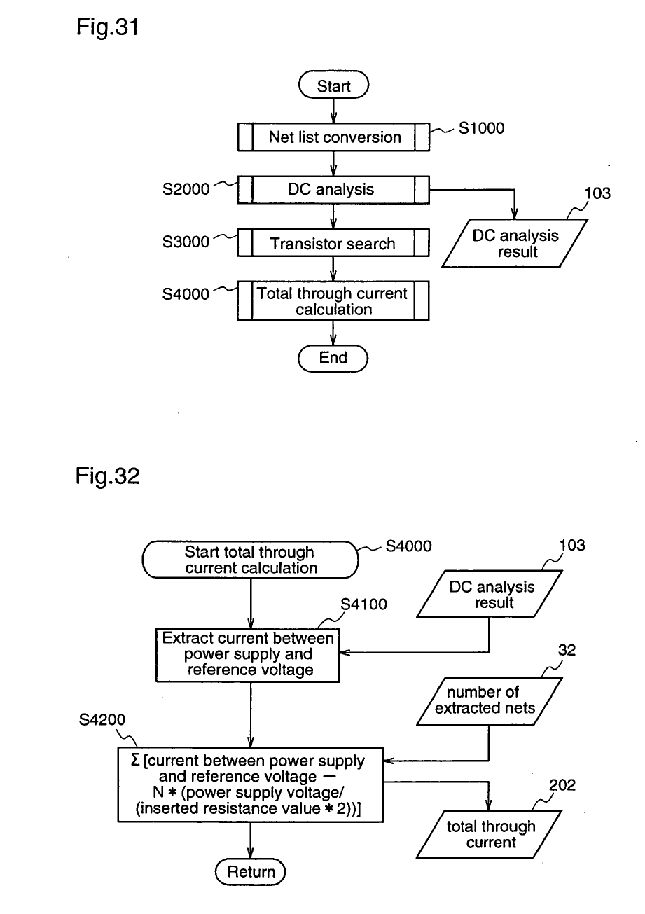

Hereinafter, the operation of the stationary through current detection apparatus 200 according to the seventh embodiment having the above-mentioned construction will be described with reference to FIGS. 31 and 32. It is assumed that stationary through currents in the circuits shown in FIGS. 37(a) and 37(b) are detected.

FIG. 31 is a diagram illustrating a series of steps of a through current detection process by the stationary through detection apparatus according to the seventh embodiment, and FIG. 32 is a diagram illustrating specific steps of a total through current calculation process included in the through current detection process shown in FIG. 31.

Initially, when the user designates a circuit to be subjected to stationary through detection by using the net list designation unit (not shown) in the net list conversion unit 30, the net list conversion unit 30 executes net list conversion on the net list of the designated target circuit (step S1000 in FIG. 31). At this time, the number of resistors which are simultaneously inserted is counted and stored in the extracted net number holding unit 32 in the net list conversion unit 30. This operation is identical to those described for the third and fifth embodiments. To be specific, in the third and fifth embodiments, the number of extracted nets is stored in the extracted net number holding unit 32. In the fifth embodiment, the number of replaced transistors is stored in the replaced transistor number holding unit 43.

Then, the DC analysis unit 101 performs DC analysis on the net list that is converted by the net list conversion unit 30 to obtain a DC analysis result, and stores this in the DC analysis result holding unit 103 in the memory 205 (step S2000 in FIG. 31). Since the operation of the DC analysis is identical to that of the conventional apparatus, repeated description is not necessary.

Thereafter, the transistor search unit 102 searches for a MOS transistor in which through current might occur, on the basis of the DC analysis result obtained by the DC analysis unit 101, and stores the result in the current through transistor database 104 in the memory 205 (step S3000 in FIG. 31). Since this process is identical to that described for the sixth embodiment using FIG. 29, repeated description is not necessary.

Then, the total through current calculation unit 201 calculates total through current, on the basis of the number of extracted nets or the number of replaced transistors, which is obtained by the net conversion unit 30, and the DC analysis result obtained by the DC analysis unit 101 (step S4000 in FIG. 31).

Hereinafter, the total through current calculation process will be described in detail with reference to FIG. 32.

Initially, a current that flows between the power supply and the reference voltage is extracted on the basis of the DC analysis result 103 which is obtained by the DC analysis unit 101 and stored in the DC analysis result holding unit 103 (step S4100 in FIG. 32). Then, the current that flows between the power supply and the reference voltage through the inserted resistor elements is subtracted from the current that flows between the power supply and the reference voltage, on the basis of the number of extracted nets for each of MOS transistors having different threshold values or the number of replaced transistors, thereby obtaining total through current. To be specific, (current between power supply and reference voltage)−N*(power supply voltage/(inserted resistor value*2)) for each power supply that is determined for each of the MOS transistors having different threshold values. Thereby, it is possible to obtain total through current that is not affected by the current flowing through the inserted resistor elements. In the above formula, N expresses Σ(number of sub-circuits X*number of nets extracted in sub-circuits X) [calculated in all sub-circuits including a top cell]. The total through current thus obtained is stored in the total through current holding unit 202.

Next, the operation of the stationary through detection apparatus 200 according to the seventh embodiment will be described in more detail using the net list shown in FIG. 26.

Initially, it is assumed that the target net list shown in FIG. 26(a) is subjected to net list conversion by the net list conversion unit 30 which is identical to the net list conversion apparatus of the fifth embodiment, and thereby the post-conversion net list shown in FIG. 26(f) is obtained.

Now it is assumed that, when detecting stationary through, a control signal ENABLE1 of OP1 and a control signal ENABLE2 of TBUF 1 are “L”. At this time, the net “a” in the circuit 3701 shown in FIG. 37(a) becomes unfixed, leading to a possibility of through current I1. Likewise, the net “d” in the circuit 3702 shown in FIG. 37(b) also becomes unfixed, leading to a possibility of through current I2. However, when the post-conversion net list 58 shown in FIG. 26(f) is subjected to DC analysis, the net “a” is fixed at a voltage at a middle point between the power supply voltage AVDD and the reference voltage due to the function of the R1002 and R1003, and the net “d” is fixed to a voltage at a middle point between the power supply voltage VDD and the reference voltage due to the function of the R1004 and R1005, whereby through currents 11 and 12 flow. Other nets operate at ordinary DC operating points.

As a result, it is possible to easily detect a position where through current that cannot be detected by the conventional DC analysis, by monitoring the respective currents in the MOS transistors MP1, MN1, MP2, and MN2.

Furthermore, it is assumed that, in step S4100, the amount of current that flows at the power supply AVDD is IAVDD and the amount of current that flows at the power supply VDD is IVDD. At this time, as shown in FIG. 26(e), the number of extracted nets relating to the power supply AVDD is “2” with respect to the top cell, and “2” with respect to the sub-circuit OP, and further, the number of sub-circuit OP is “1”. Likewise, the number of extracted nets relating to the power supply VDD is “2” with respect to the top cell. Consequently, the total through current is expressed as (IAVDD−(2+2*1)(AVDD/(100T*2)) with respect to the power supply AVDD, and it is expressed as (IVDD−(2)(VDD/(100T*2)) with respect to the power supply VDD.

As described above, according to the seventh embodiment, the net list of the stationary through detection target circuit is subjected to net list conversion so as to insert a resistor in a position where through current might occur, and thereafter, current of the MOS transistor is monitored. Therefore, it is possible to easily detect a position where leakage current might occur, which position is difficult to be detected by the ordinary DC analysis.

Further, according to the seventh embodiment, it is possible to calculate the through current that occurs in the net list of the detection target circuit.

### Embodiment 8

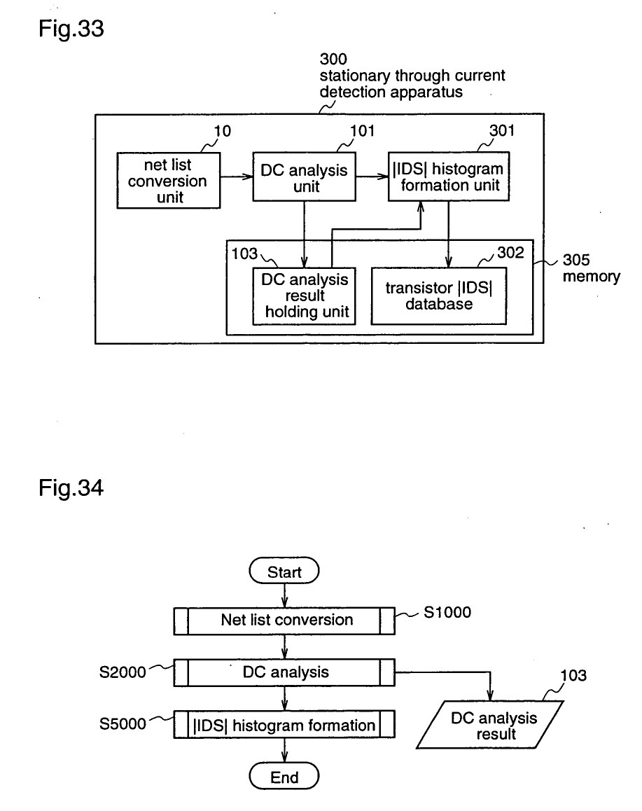

Hereinafter, a stationary through detection apparatus 300 according to an eighth embodiment will be described with reference to FIGS. 33˜36.

While in the sixth embodiment positions where stationary through currents occur are searched, in this eighth embodiment positions where through currents occur are graphed.

Initially, the construction of the stationary through detection apparatus 300 according to the eighth embodiment will be described with reference to FIG. 33. FIG. 33 is a diagram illustrating the construction of the stationary through detection apparatus according to the eighth embodiment.

In FIG. 33, the stationary through detection apparatus 300 comprises a net list conversion unit 10, a DC analysis unit 101, a |IDS| histogram formation unit 301, and a memory 305 comprising a DC analysis result holding unit 103 and a transistor |IDS| database 302.

More specifically, the net list conversion unit 10 converts a net list of a stationary through detection target circuit so as to insert a resistor in a position where through current might occur, and the construction thereof is identical to any of those according to the first to fifth embodiments. The |IDS| histogram formation unit 301 forms a MOS transistor |IDS| histogram on the basis of the DC analysis result obtained by the DC analysis unit 101. The transistor |IDS| database 302 in the memory 305 holds the MOS transistor |IDS| obtained by the |IDS| histogram formation unit 301. Since other constituents are identical to those of the sixth embodiment, repeated description is not necessary.

Hereinafter, the operation of the stationary through detection apparatus 300 of the eighth embodiment having the above-mentioned construction will be described with reference to FIGS. 34˜36. It is assumed that stationary through currents in the above-mentioned FIGS. 37(a) and 37(b) will be detected.

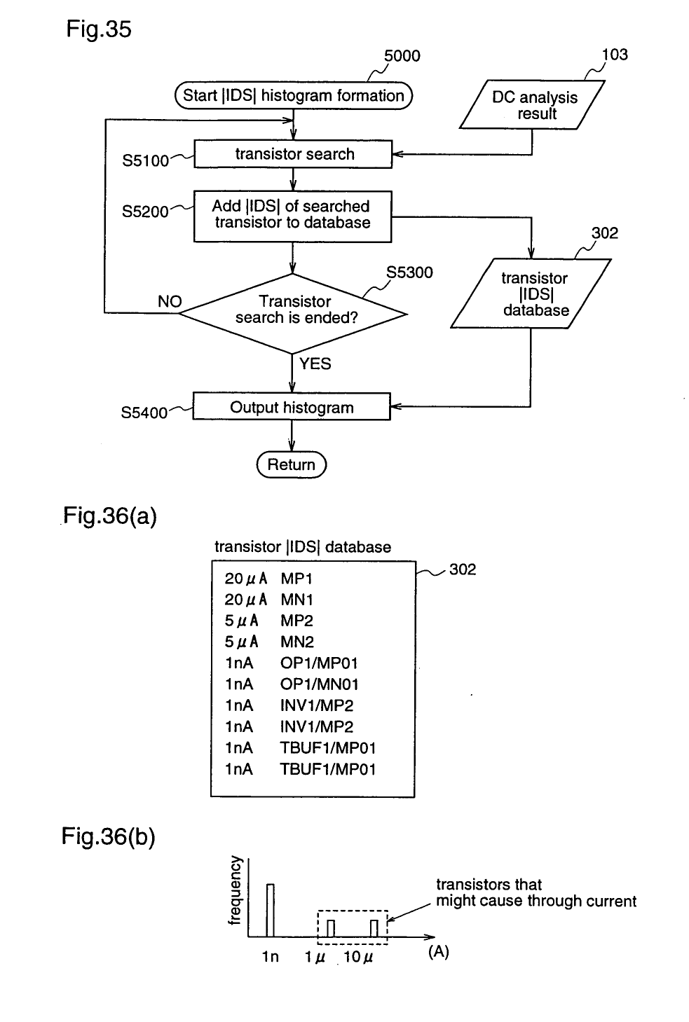

FIG. 34 is a diagram illustrating a series of steps of a through current detection process by the stationary through current detection apparatus according to the eighth embodiment. FIG. 35 is a diagram illustrating specific steps of a |IDS| histogram formation process included in the through current detection process shown in FIG. 34. FIG. 36(a) is a diagram illustrating a transistor |IDS| database obtained by the |IDS| histogram formation unit, and FIG. 36(b) is a diagram illustrating a histogram obtained by the database shown in FIG. 36(a).

Initially, when a user designates a circuit to be subjected to stationary through current detection by using the net list designation unit (not shown) included in the net list conversion unit 10, the net list conversion unit 10 executes net list conversion to the net list of the designated target circuit (step S1000 in FIG. 34). This operation is as described for the first to fifth embodiments.

Then, the DC analysis unit 101 executes DC analysis on the net list converted by the net list conversion unit 10 to obtain a DC analysis result, and stores this in the DC analysis result holding unit 103 in the memory 105 (step S2000 in FIG. 34). Since the operation of DC analysis is identical to the conventional DC analysis, repeated description is not necessary.

Thereafter, the |IDS| histogram formation unit 301 forms a MOS transistor |IDS| histogram on the basis of the DC analysis result obtained by the DC analysis unit 101 (step S5000 in FIG. 34).

Hereinafter, the |IDS| histogram formation process will be described with reference to FIG. 35.

Initially, transistors are searched on the basis of the DC analysis result obtained by the DC analysis unit 101 (step S5100 in FIG. 35). Then, the |IDS| of the searched transistors are added to the transistor |IDS| database 302 in the memory 305 (step S5200 in FIG. 35).

Thereafter, it is checked whether the transistor search based on the DC analysis result in steps S5100˜S5200 is ended or not (step S5300 in FIG. 35). When the transistor search is ended, the processing is ended; otherwise, the processing returns to step S5100 to repeat the above-mentioned steps.

Then, a |IDS| histogram is formed from the transistor |IDS| database 302, and outputted (step S5400 in FIG. 35).

Next, the operation of the stationary through current detection apparatus 300 according to the eighth embodiment will be described in more detail using the net list shown in FIG. 26. It is assumed that the net list conversion unit 10 corresponds to the net list conversion apparatus according to the fifth embodiment.

Initially, it is assumed that the target net list shown in FIG. 26(a) is subjected to net list conversion by the net list conversion unit 10 identical to the net list conversion apparatus of the fifth embodiment to obtain the post-conversion net list shown in FIG. 26(f).

Now it is assumed that, when detecting stationary through current, a control signal ENABLE1 of OP1 and a control signal ENABLE2 of TBUF 1 are “L”. At this time, the net “a” in the circuit 3701 shown in FIG. 37(a) becomes unfixed, leading to a possibility of through current I1. Likewise, the net “d” in the circuit 3702 shown in FIG. 37(b) also becomes unfixed, leading to a possibility of through current I2.

However, when the post-conversion net list 58 shown in FIG. 26(f) is subjected to DC analysis, the net “a” is fixed at a voltage at a middle point between the power supply voltage AVDD and the reference voltage due to the function of the R1002 and R1003, and the net “d” is fixed to a voltage at a middle point between the power supply voltage VDD and the reference voltage due to the function of the R1004 and R1005, whereby through currents 11 and 12 flow. Other nets operate at ordinary DC operating points.

Assuming that the |IDS| of the MOS transistor MP1 and the |IDS| of the MN1 are 20 μA, the |IDS| of the MP2 and the |IDS| of the MN2 are 5 μA, and the |IDS| of other transistors are 1 nA, the transistor |IDS| database 302 obtained by the |IDS| histogram formation unit 301 at this time is shown in FIG. 36(a), and further, the histogram obtained at this time is shown in FIG. 36(b).

As described above, since the |IDS| of the respective MOS transistors are expressed by the |IDS| histogram, it is possible to visually confirm as to which MOS transistor has a possibility of through current.

As described above, according to the eighth embodiment, the net list of the stationary through detection target circuit is subjected to net list conversion so as to insert a resistor in a position where through current might occur, and thereafter, current of the MOS transistor is monitored. Therefore, it is possible to easily detect a position where leakage current might occur, which position is difficult to be detected by the ordinary DC analysis. Further, according to the eighth embodiment, since the |IDS| histogram formation unit 301 expresses the |IDS| of the MOS transistors by the |IDS| histogram, it is possible to visually detect a position having a possibility of through current.

The order of the respective steps described for each of the embodiments is not restricted to that mentioned above, i.e., the steps may be in the order so long as the same effects as mentioned above can be obtained.

Further, the descriptions in such as the extracted net database 14, the resistor element name database 16, and the extracted net number holding unit 32 according to the respective embodiments are not restricted to those shown in the drawings, any descriptions may be employed so long as the same effects as mentioned above can be obtained.

Furthermore, in the respective embodiments described above, the resistance of the resistor element inserted in the net list is 100T (refer to FIG. 5(c)). However, the resistor element may have a high resistance (several GOhm˜several hundreds TOhm) so long as it does not affect the operation of another circuit.

Furthermore, the respective embodiments are described as the net list conversion apparatus or the stationary through current detection apparatus. However, a program for making a computer automatically perform a net list conversion process or a stationary through current detection process by the above-mentioned apparatus may be created, and the net list conversion process or the stationary through current detection process may be automatically performed on the detection target circuit with a computer.

### APPLICABILITY IN INSUSTRY

A net list conversion apparatus and a stationary through current detection apparatus according to the present invention facilitate development of a low-power-consumption system, and realize long-hour operation and energy-saving of mobile terminals.

1. A net list conversion method comprising:
a net list designation step of designating a net list to be subjected to detection of through current in a stationary state;
a net extraction step of extracting a net connected to a gate terminal of a MOS transistor from the detection target net list, and storing the extracted net in a extracted net database which is provided for each of MOS transistors having different threshold values; and
a resistor insertion step of inserting a resistor element having a high resistance value which does not affect the operations of circuits other than the extracted MOS transistor, between the extracted net that is connected to the gate terminal of the extracted MOS transistor and a power supply that is determined for each threshold value of the MOS transistor, and between the extracted net and a reference voltage, respectively, in the detection target net list, on the basis of the extracted net database that is provided for each of the MOS transistors having different threshold values.

2. A net list conversion method as defined in claim 1 wherein said net extraction step comprises:
a MOS transistor detection step of detecting a MOS transistor in the detection target net list;
a net detection step of detecting a net connected to a gate terminal of the detected MOS transistor, and storing the detected net in the extracted net database; and
a resistor element detection step of detecting a resistor element in the detected target net list, and storing a resistor element name of the detected resistor element in a resistor element name database.

3. A net list conversion method as defined in claim 2 wherein said MOS transistor detection step checks whether a first character in each row included in the detection target net list is “M” or not, and determines that the corresponding row describes about a MOS transistor when the first character in the row is “M”.

4. A net list conversion method as defined in claim 2 wherein said net detection step comprises:
detecting, from a row determined as describing about a MOS transistor in the MOS transistor detection step, a net connected to the gate terminal of the MOS transistor;
determining a threshold value of the MOS transistor from a model name of the MOS transistor, said model name being indicated by a sixth character string in the row; and
storing the net that is connected to the gate terminal of the MOS transistor, in a database of the corresponding threshold value among the extracted net databases which are provided for the respective threshold values of the MOS transistor.

5. A net list conversion method as defined in claim 2 wherein said resistor element detection step comprises:
checking whether a first character in each row included in the detection target net list is “R” or not, and determines that the corresponding row describes about a resistor element when the first character in the row is “R”;
extracting a first character string in the row that is determined as describing about a resistor element, as a resistor element name of the resistor element; and
storing the extracted resistor element name in the resistor element name database.

6. A net list conversion method as defined in claim 1 wherein said resistor insertion step comprises:
creating a new resistor element name to be a unique resistor element name by searching the resistor element name database;
adding a resistor element having the created new resistor element name into the net list, between a net that is stored in the extracted net database which is provided for each of MOS transistors having different threshold values and the power supply that is determined for each threshold value of the MOS transistor, and between the stored net and the reference voltage; and
adding the resistor element names of the added resistor elements into the resistor element name database.

7. A net list conversion method as defined in claim 1 further including:
an overlapping net deletion step of deleting a net that overlaps in each extracted net database, among the nets extracted in the net extraction step and stored in the extracted net database which is provided for each of MOS transistors having difference threshold values, and
said resistor insertion step inserting the resistor element, between the net connected to the gate terminal of the MOS transistor and the power supply that is determined for each threshold value of the MOS transistor, and between the net and the reference voltage, respectively, in the detection target net list, on the basis of the extracted net database from which the overlapping net is deleted by the overlapping net deletion step.

8. A net list conversion method as defined in claim 7 wherein said overlapping net deletion step comprises:
reading the extracted net database that is provided for each of MOS transistors having different threshold values;
rearranging the nets stored in the read extracted net database in lexicographical order; and
searching the rearranged extracted net database from the beginning, and deleting a net that is identical to a net as a search target.

9. A net list conversion method as defined in claim 1 further including a net number counting step of reading the extracted net database that is provided for each of MOS transistors having different threshold values, and counting, for each extracted net database, the number of nets included in the extracted net database.

10. A net list conversion method comprising:
a net list designation step of designating a net list to be subjected to detection of through current in a stationary state;
a sub-circuit replacement step of replacing a MOS transistor in the detection target net list with a sub-circuit according to a threshold value and type of the MOS transistor; and
a sub-circuit addition step of adding, into the detection target net list, sub-circuit information of the sub-circuit with which the MOS transistor is replaced; and
said sub-circuit information including a MOS transistor according to a threshold value and type of the MOS transistor that is replaced with the sub-circuit, and resistor elements each having a resistance value that does not affect the operations of circuits other than the MOS transistor, said resistor elements being inserted between the gate terminal of the MOS transistor and a power supply according to the threshold value of the MOS transistor, and between the gate terminal of the MOS transistor and a reference voltage, respectively.

11. A net list conversion method as defined in claim 10 further including a replaced transistor number counting step of counting the number of MOS transistors that are replaced with sub-circuits according to the threshold values and types of the MOS transistors by the sub-circuit replacement step.

12. A net list conversion method as defined in claim 10 wherein said sub-circuit replacement step comprises:
detecting a MOS transistor in the detection target net list;
determining a threshold value of the MOS transistor from a model name of the MOS transistor, said model name being indicated by a sixth character string in a row that describes about the detected MOS transistor;
replacing the description of the detected MOS transistor with a sub-circuit according to the threshold value and type of the MOS transistor; and
adding “X” at the top of a first character string in a row of the sub-circuit with which the MOS transistor is replaced, and describing, in the row, connection information comprising “drain terminal”, “gate terminal”, “source terminal”, and “bulk terminal” and parameter information comprising “W:channel width”, “L:channel length”, “M:multiplier”, which correspond to second, third, fourth and fifth character strings of the description of the MOS transistor before being replaced with the sub-circuit.

13. (canceled)

14. A net list conversion method comprising:
a net list designation step of designating a net list to be subjected to detection of through current in a stationary state;
a first net extraction step of extracting a net connected to a gate terminal of a MOS transistor from the detection target net list, and storing the extracted net in an extracted net database which is provided for each of MOS transistors having different threshold values;
a second net extraction step of extracting a net connected to an input terminal of a sub-circuit from the detection target net list, and storing the extracted not in an extracted net database which is provided for each of the MOS transistors having different threshold values; and
a resistor insertion step of inserting a resistor element having a high resistance value which does not affect the operations of circuits other than the MOS transistor or the sub-circuit, between the net extracted in the first net extraction step and the second net extraction step and a power supply, and between the extracted net and a reference voltage, respectively, in the detection target net list, on the basis of the extracted net database that is provided for each of the MOS transistors having different threshold values.

15. A net list conversion method as defined in claim 14 wherein said second net extraction step checks whether a first character in each row included in the detection target net list is “X” or not, and determines that the corresponding row describes about a sub-circuit when the first character in the row is “X”.

16. A net list conversion method as defined in claim 14 further including:
an overlapping net deletion step of deleting a net that overlaps in each extracted net database, among the nets extracted in the first net extraction step and the second net extraction step and then stored in the extracted net database which is provided for each of MOS transistors having difference threshold values, and
said resistor insertion step inserting the resistor element, between the net extracted in the first net extraction step and the second net extraction step and the power supply, and between the extracted net and the reference voltage, respectively, in the detection target net list, on the basis of the extracted net database from which the overlapping net is deleted in the overlapping net deletion step.

17. A net list conversion method as defined in claim 16 further including a net number counting step of reading the extracted net database that is provided for each of the MOS transistors having different threshold values, and counting the number of nets included in the extracted net database, for each extracted net database.

18. A net list conversion method as defined in claim 14 further including:
a comparison step of comparing the sub-circuit extracted in the second net extraction step with a sub-circuit database in which specific sub-circuit is entered;
said resistor insertion step
inserting a resistor element having a high resistance value which does not affect the operations of circuits other than the MOS transistor, between the net extracted in the first net extraction step and the power supply, and between the extracted net and the reference voltage, respectively, in the detection target net list, on the basis of the extracted net database that is provided for each of the MOS transistors having different threshold values, and
inserting a resistor element having a high resistance value which does not affect the operations of circuits other than the sub-circuit, between a net other than a net included in a sub-circuit that is determined as being entered in the sub-circuit database in the comparison step among the sub-circuits extracted in the second net extraction step and the power supply, and between the net and the reference voltage, respectively, in the detection target net list.

19. A net list conversion apparatus comprising:
a net list designation unit for designating a net list to be subjected to detection of through current in a stationary state;
a net extraction unit for extracting a net connected to a gate terminal of a MOS transistor from the detection target net list, and storing the extracted net in a extracted net database which is provided for each of MOS transistors having different threshold values; and
a resistor insertion unit for inserting a resistor element having a high resistance value which does not affect the operations of circuits other than the extracted MOS transistor, between the extracted net that is connected to the gate terminal of the extracted MOS transistor and a power supply that is determined for each threshold value of the MOS transistor, and between the extracted net and a reference voltage, respectively, in the detection target net list, on the basis of the extracted net database that is provided for each of the MOS transistors having different threshold values.

20. A net list conversion apparatus as defined in claim 19 further including:
an overlapping net deletion unit for deleting a net that overlaps in each extracted net database, among the nets extracted by the net extraction unit and stored in the extracted net database which is provided for each of the MOS transistors having difference threshold values, and
said resistor insertion unit inserting the resistor element, between the net connected to the gate terminal of the MOS transistor and the power supply that is determined for each threshold value of the MOS transistor, and between the net and the reference voltage, respectively, in the detection target net list, on the basis of the extracted net database from which the overlapping net is deleted by the overlapping net deletion unit.

21. A net list conversion apparatus as defined in claim 19 further including a net number counting unit for reading the extracted net database that is provided for each of MOS transistors having different threshold values, and counting, for each extracted net database, the number of nets included in the extracted net database.

22. A net list conversion apparatus comprising:
a net list designation unit for designating a net list to be subjected to detection of through current in a stationary state;
a sub-circuit replacement unit for replacing a MOS transistor in the detection target net list with a sub-circuit according to a threshold value and type of the MOS transistor; and
a sub-circuit addition unit for adding, into the detection target net list, sub-circuit information of the sub-circuit with which the MOS transistor is replaced; and
said sub-circuit information including a MOS transistor according to a threshold value and type of the MOS transistor that is replaced with the sub-circuit, and resistor elements each having a resistance value that does not affect the operations of circuits other than the MOS transistor, said resistor elements being inserted between the gate terminal of the MOS transistor and a power supply according to the threshold value of the MOS transistor, and between the gate terminal of the MOS transistor and a reference voltage, respectively.

23. A net list conversion apparatus as defined in claim 22 further including a replaced transistor number counting unit for counting the number of MOS transistors that are replaced with sub-circuits according to the threshold values and types of the MOS transistors by the sub-circuit replacement unit.

24. A net list conversion apparatus comprising:
a net list designation unit for designating a net list to be subjected to detection of through current in a stationary state;
a first net extraction unit for extracting a net connected to a gate terminal of a MOS transistor from the detection target net list, and storing the extracted net in an extracted net database which is provided for each of MOS transistors having different threshold values;
a second net extraction unit for extracting a net connected to an input terminal of a sub-circuit from the detection target net list, and storing the extracted not in an extracted net database which is provided for each of the MOS transistors having different threshold values; and
a resistor insertion unit for inserting a resistor element having a high resistance value which does not affect the operations of circuits other than the MOS transistor or the sub-circuit, between the net extracted by the first net extraction unit and the second net extraction unit and a power supply, and between the extracted net and a reference voltage, respectively, in the detection target net list, on the basis of the extracted net database that is provided for each of the MOS transistors having different threshold values.

25. A net list conversion apparatus as defined in claim 24 further including:
an overlapping net deletion unit for deleting a net that overlaps in each extracted net database, among the nets extracted by the first net extraction unit and the second net extraction unit and then stored in the extracted net database which is provided for each of MOS transistors having difference threshold values, and
said resistor insertion unit inserting the resistor element, between the net extracted by the first net extraction unit and the second net extraction unit and the power supply, and between the extracted net and the reference voltage, respectively, in the detection target net list, on the basis of the extracted net database from which the overlapping net is deleted by the overlapping net deletion unit.

26. A net list conversion apparatus as defined in claim 24 further including a net number counting unit for reading the extracted net database that is provided for each of the MOS transistors having different threshold values, and counting the number of nets included in the extracted net database, for each extracted net database.

27. A stationary through current detection method comprising:
a net list conversion step of converting a net list to be subjected to detection of through current in a stationary state, by using a net list conversion method according to claim 1;
a DC analysis step of subjecting a post-conversion net list obtained in the net list conversion step to DC analysis to obtain a DC analysis result; and
a transistor search step of searching for a MOS transistor in which through current might occur, in the detection target net list, on the basis of the DC analysis result obtained in the DC analysis step.

28. A stationary through current detection method as defined in claim 27 wherein said transistor search step comprising:
determining, on the basis of the DC analysis result, as to whether a current |ids| that flows in a MOS transistor in the detection target net list exceeds a predetermined current threshold value Ith or not; and
storing a MOS transistor in which the current |ids| exceeds the current threshold value Ith, as a current through MOS transistor, in a current through MOS transistor database.

29. A stationary through current detection method comprising:
a net list conversion step of converting a net list to be subjected to detection of through current in a stationary state, by using a net list conversion method according to claim 1;
a DC analysis step of subjecting a post-conversion net list obtained in the net list conversion step to DC analysis to obtain a DC analysis result;
a transistor search step of searching for a MOS transistor in which through current might occur, in the detection target net list, on the basis of the DC analysis result obtained in the DC analysis step; and
a total through current calculation step of calculating total through current in the detection target net list.

30. A stationary through current detection method as defined in claim 29 wherein said total through current calculation step subtracts (number of extracted nets*((power supply voltage−reference voltage)/(inserted resistance value*2)) or (number of replaced transistors*((power supply voltage-reference voltage)/(inserted resistance value*2)) from a current which flows between the power supply that is determined for each threshold value of the MOS transistor and the reference voltage, on the basis of the DC analysis result, and the number of nets included in the extracted net database or the number of MOS transistors replaced with sub-circuits.

31. A stationary through current detection method comprising:
a net list conversion step of converting a net list to be subjected to detection of through current in a stationary state, by using a net list conversion method according to claim 1; and
a histogram formation step of subjecting a post-conversion net list obtained in the net list conversion step to DC analysis, and forming a histogram relating to through currents |Ids| in MOS transistors in the detection target net list on the basis of the DC analysis result.

32. A stationary through current detection apparatus comprising:
a net list conversion unit for converting a net list to be subjected to detection of through current in a stationary state, by using a net list conversion apparatus according to claim 1;
a DC analysis unit for subjecting a post-conversion net list obtained by the net list conversion unit to DC analysis to obtain a DC analysis result; and
a transistor search unit for searching for a MOS transistor in which through current might occur, in the detection target net list, on the basis of the DC analysis result obtained by the DC analysis unit.

33. A stationary through current detection apparatus comprising:
a net list conversion unit for converting a net list to be subjected to detection of through current in a stationary state, by using a net list conversion apparatus according to claim 1;
a DC analysis unit for subjecting a post-conversion net list obtained by the net list conversion unit to DC analysis to obtain a DC analysis result;
a transistor search unit for searching for a MOS transistor in which through current might occur, in the detection target net list, on the basis of the DC analysis result obtained by the DC analysis unit; and
a total through current calculation unit for calculating total through current in the detection target net list.

34. A stationary through current detection apparatus comprising:
a net list conversion unit for converting a net list to be subjected to detection of through current in a stationary state, by using a net list conversion apparatus according to claim 1; and
a histogram formation unit for subjecting a post-conversion net list obtained by the net list conversion unit to DC analysis, and forming a histogram relating to through currents |Ids| in MOS transistors in the detection target net list on the basis of the DC analysis result.

35. A net list conversion program for making a computer execute a net list conversion process for a net list to be subjected to detection of through current in a stationary state, said net list conversion program comprising:
a net list designation step of designating the net list;
a net extraction step of extracting a net connected to a gate terminal of a MOS transistor from the detection target net list, and storing the extracted net in a extracted net database which is provided for each of MOS transistors having different threshold values; and
a resistor insertion step of inserting a resistor element having a high resistance value which does not affect the operations of circuits other than the extracted MOS transistor, between the extracted net that is connected to the gate terminal of the extracted MOS transistor and a power supply that is determined for each threshold value of the MOS transistor, and between the extracted net and a reference voltage, respectively, in the detection target net list, on the basis of the extracted net database that is provided for each of the MOS transistors having different threshold values.

36. A net list conversion program for making a computer execute a net list conversion process for a net list to be subjected to detection of through current in a stationary state, said net list conversion program comprising:
a net list designation step of designating the net list;
a sub-circuit replacement step of replacing a MOS transistor in the detection target net list with a sub-circuit according to a threshold value and type of the MOS transistor; and
a sub-circuit addition step of adding, into the detection target net list, sub-circuit information of the sub-circuit with which the MOS transistor is replaced; and
said sub-circuit information including a MOS transistor according to a threshold value and type of the MOS transistor that is replaced with the sub-circuit, and resistor elements each having a resistance value that does not affect the operations of circuits other than the MOS transistor, said resistor elements being inserted between the gate terminal of the MOS transistor and a power supply according to the threshold value of the MOS transistor, and between the gate terminal of the MOS transistor and a reference voltage, respectively.

37. A net list conversion program for making a computer execute a net list conversion process for a net list to be subjected to detection of through current in a stationary state, said net list conversion program comprising:
a net list designation step of designating the net list;
a first net extraction step of extracting a net connected to a gate terminal of a MOS transistor from the detection target net list, and storing the extracted net in an extracted net database which is provided for each of MOS transistors having different threshold values;
a second net extraction step of extracting a net connected to an input terminal of a sub-circuit from the detection target net list, and storing the extracted not in an extracted net database which is provided for each of the MOS transistors having different threshold values; and
a resistor insertion step of inserting a resistor element having a high resistance value which does not affect the operations of circuits other than the MOS transistor or the sub-circuit, between the net extracted in the first net extraction step and the second net extraction step and a power supply, and between the extracted net and a reference voltage, respectively, in the detection target net list, on the basis of the extracted net database that is provided for each of the MOS transistors having different threshold values.

38. A stationary through current detection program for making a computer execute a stationary through current detection process for a net list to be subjected to detection of through current in a stationary state, said stationary through current detection program comprising:
a net list conversion step of converting a net list to be subjected to detection of through current in a stationary state, by using a net list conversion method according to claim 1;
a DC analysis step of subjecting a post-conversion net list obtained in the net list conversion step to DC analysis to obtain a DC analysis result; and
a transistor search step of searching for a MOS transistor in which through current might occur, in the detection target net list, on the basis of the DC analysis result obtained in the DC analysis step.

39. A stationary through current detection program for making a computer execute a stationary through current detection process for a net list to be subjected to detection of through current in a stationary state, said stationary through current detection program comprising:
a net list conversion step of converting a net list to be subjected to detection of through current in a stationary state, by using a net list conversion method according to claim 1;
a DC analysis step of subjecting a post-conversion net list obtained in the net list conversion step to DC analysis to obtain a DC analysis result;
a transistor search step of searching for a MOS transistor in which through current might occur, in the detection target net list, on the basis of the DC analysis result obtained in the DC analysis step; and
a total through current calculation step of calculating total through current in the detection target net list.

40. A stationary through current detection program for making a computer execute a stationary through current detection process for a net list to be subjected to detection of through current in a stationary state, said stationary through current detection program comprising:
a net list conversion step of converting a net list to be subjected to detection of through current in a stationary state, by using a net list conversion method according to claim 1; and
a histogram formation step of subjecting a post-conversion net list obtained in the net list conversion step to DC analysis, and forming a histogram relating to through currents |Ids| in MOS transistors in the detection target net list on the basis of the DC analysis result.
